(19) United States
(12) Patent Application Publication
(10) Pub. No.: US 2020/0067128 A1
(43) Pub. Date: Feb. 27, 2020

(54) HYBRID AND SOLID-STATE BATTERY ARCHITECTURES WITH HIGH LOADING AND METHODS OF MANUFACTURE THEREOF

(71) Applicant: FISKER INC., Los Angeles, CA (US)

(72) Inventors: John Chmiola, Scranton, PA (US); Lawrence A Renna, Huntington Beach, CA (US); Vincent Giordani, Signal Hill, CA (US); Sean Barrett, Bigfork, MT (US); Sam Keene, Long Beach, CA (US); Fabio Albano, Playa Vista, CA (US); Martin Welch, Hermosa Beach, CA (US)

(21) Appl. No.: 16/549,687

(22) Filed: Aug. 23, 2019

Related U.S. Application Data
(63) Continuation-in-part of application No. PCT/US2017/060546, filed on Nov. 8, 2018.
(60) Provisional application No. 62/722,266, filed on Aug. 24, 2018.

(51) Int. Cl. H01M 10/058; H01M 10/0525; H01M 10/0562

(52) U.S. Cl. CPC H01M 10/058; H01M 2300/0071; H01M 10/0562; H01M 10/0525

(57) ABSTRACT

Solid state or bulk hybrid batteries comprising a plurality of composite electrodes with high loading of electrochemically-active materials, a dendrite-blocking separator placed between the anode and the cathode, a secondary phase between the electrochemically-active materials and the solid-state or hybrid electrolyte and methods thereof are disclosed. Methods of making and using the same are also disclosed.

### RELATED APPLICATIONS

This application claims the benefit of priority to International application No. PCT/US2017/060546 filed on Nov. 8, 2018, U.S. provisional patent application No. 62/419,423 filed on Nov. 8, 2016, U.S. provisional patent application No. 62/722,266 filed on Aug. 24, 2018, U.S. provisional patent application No. 62/722,362 filed on Aug. 24, 2018, and U.S. provisional patent application No. 62/722,287 filed on Aug. 24, 2018, all of which are incorporated by reference herein.

### FIELD OF THE INVENTION

The present invention relates to bulk hybrid or solid-state batteries consisting of a plurality of composite electrodes with high loading of electrochemically-active materials into an ionically and/or electronically conducting solid-state or hybrid scaffold, a dendrite-blocking separator placed between the anode and the cathode, a secondary phase between the electrochemically-active materials to facilitate low interfacial impedance and the solid-state or hybrid electrolyte and methods thereof

### BACKGROUND

The electric vehicle (EV) battery pack performs the same function as the gasoline tank in a conventional vehicle; it stores the energy needed to operate the vehicle. Gasoline tanks can store the energy to drive the vehicle 300-500 miles before refilling; however, current generation batteries only offer capacities of 50-200 miles in affordable vehicles and up to a maximum of 335 miles in expensive large luxury vehicles.

Thus, EVs require 30-40 kWh battery packs for a reasonable mileage range and must possess a long cycle life. This imposes practical needs for high energy density and cycle lifetime. United States Advanced Battery Consortium LLC (USABC) targets for EV battery pack performance are listed in Table I, below:

TABLE I
USABC Battery (System Level) Performance Goals for EVs

| | Energy | Power | Dynamic | |
|---|---|---|---|---|
| | Density | Density | Stress Test | Cost |
| | (Wh/kg) | (W/kg) | Cycle Life | ($/kWh) |
| Current 12 V | 35 | 150 | 500 | 150 |
| Pb-A | | | | |
| USABC mid- | 80 | 150 | 600 | 250 |
| term goals | | | | |
| USABC long- | 235 | 470 | 1,000 | <100 |
| term goals | | | | |

Lithium-ion batteries (LIBs) and Li-metal polymer batteries (LMPBs) are the most advanced commercial energy storage technologies to-date. However, the combined requirements of energy density and power density, cost, and safety for real applications have not been met. Significant improvement towards one of these requirements often compromises the others. Indeed, all high-energy density LIBs suffer from infrequent catastrophic failure as well as poor cycle performance. As LIBs increase in energy and power densities, there is a continuing mandate to develop Li⁺ electrolytes that operate under extremely harsh conditions.

LIBs are the most promising technology for the widespread use of EVs. However, current industry strategies (e.g., high voltage and high capacity active materials) to achieve high gravimetric and volumetric energy densities accelerate degradation mechanisms, capacity loss, capacity fade, power fade, and voltage fade. These are caused by solid-electrolyte interphase (SEI) growth, cathode structure phase changes, gassing, and parasitic side reactions at anodes and cathodes. High capacity anodes such as silicon anodes experience excessive volume changes on cycling, ˜300% compared to 10% for graphite, which generally leads to rapid mechanical degradation.

Li metal anodes offer very high energy densities, 3860 mAh/g; however, safety and cyclability remain limitations that must be addressed for them to be deployed in any practical systems. In general, traditional LiBs are limited in energy density largely for 3 reasons.

Thickness of electroactive layers is limited to less than 100 μm due to low electrical conductivity cathode materials which results in a higher fraction of non-electroactive materials in the cell.

Solvent oxidation and Aluminum current collector corrosion occur when using cathodes with electrochemical potentials higher than approximately 4.5V vs. Li/Li⁺ electrochemical potentials substantially above (cathodes) or below (anodes) the standard hydrogen potential [Ma, T., 2017, J. Phys. Chem. Lett., 8, 5, 1072-1077].

Slow ionic diffusion processes, both within the electrochemically active materials and within the electrolyte that take place during charge and discharge.

As stated previously, thick electrodes are desirable because they result in higher energy density cells due to a lower fraction of electrochemically inactive materials required for the battery to function. However, thick electrodes manufactured with traditional particulate slurry coating methods result in high resistance that limits the amount of power that a battery can output. In order to design more powerful cells, manufacturers have to design thin electrodes—limiting the coating thickness to below 100 μm and typically around 40 μm—resulting in a trade-off of energy for power.

There is thus a need for thicker electrodes which address the problems of high electronic resistance, high ionic resistance and electrochemical compatibility with high energy density materials which opens up the design space of cell engineering reforming the boundaries of traditional manufacturing and allowing for a more optimized system that can leverage all the active and inactive materials effectively. The physics-based factors that limit the energy/power density boil down to increased cell polarization and underutilization of active materials. Both are affected by Li-ion diffusion in active materials which are not equipotential due to finite electronic and ionic resistance throughout the electrode bulk. The first also develops due to Li⁺ gradients that develop within the electrolyte and can be minimized through increasing Li⁺ concentrations greater than 1.0M, increasing ionic conductivity or a combination. The underutilization of active materials in thick electrodes could be addressed by increasing solid-state diffusion in the active materials, improving electronic conductivity through the electrode thickness, reducing Li⁺ gradients in the electrolyte phase.

In addition to these fundamental concerns, thick electrodes (>100 μm) processed using standard powder processing methodologies have concerns with delamination from the current collector, electrochemically-active particles becoming loose and mobile within the cell, and lithium plating at the anode during charge at even moderate rates of C/10 [Singh, M., 2016, Batteries, 2, 35, 1-11].

Previously it was demonstrated that c-LLZO and LiTi₂(PO₄)₃ Li+ conducting films by processing NPs can provide films <30 μm thick with ion conductivities ˜1 mS cm⁻¹. Details are described, for instance, in Eongyu Yi et al., “Flame made nanoparticles permit processing of dense, Li+ conducting ceramic electrolyte thin films of cubic-Li₇La₃Zr₂O₁₂ (c-LLZO),” J. Mater. Chem. A, 2016, 4, 12947-12954. These prior art films suffer from several deficiencies including: they have very little to no conductivity at temperatures of 0° C. or less; they require high sintering temperatures well above 1,110° C. and very long sintering times. All of these drawbacks make these films impractical for use in commercial batteries.

Lithium plating at the anode during charge would not be problematic if lithium plated smoothly, however Lithium tends to plate as long filaments even at low current densities which can grow across the cell and cause short circuiting [Xu, W., 2014, Energy & Environmental Science, 7, 513-537]. This short circuiting causes rapid discharge of the cell, excessive heating, and could cause thermal runaway and cell fires. Seminal work by Newman showed that if the electrolyte was a solid with sufficient stiffness, dendrite growth and propagation could be retarded, giving birth to a substantial body of work on solid-polymer electrolytes. Solid-polymer batteries were introduced by Sony and Bellcore in the late 1990's, but suffered a number of issues, with the predominant one being very high impedance to do the low conductivity polymer electrolytes being used. Operating at elevated temperature or adding a solvent to “gel” the polymer served to aid in reducing the cell impedance, allowing thicker active material layers, but increased safety concerns because of the reduced critical current density for dendrite growth and increased concerns with thermal runaway.

Additionally, current Li-Ion battery technology presents safety concerns related to the use of organic electrolytes due to their flammability. Thermal runaway associated with exothermic reactions due to shorts inside the cell that are initiated by excessive heat from inside or outside the cell can lead to fire. Electrolyte additives such as fluorinated co-solvents that can lower the flammability and increase safety have been proposed [P. G. Balakrishnan et al. 2006 Journal of Power Sources 155 401-414; Q. Wang et al. 2012 Journal of Power Sources 208, 210-224; T. M. Bandhauer et al. 2011 Journal of Electrochemical Society 158 R1-R25; G Park et al. 2009 Journal of Power Sources 189 602-606; P. Biensan et al. 1999 Journal of Power Sources 81 906-912; G. E. Blomgren 2017 Journal of the Electrochemical Society 164 A5019-A5025].

Solid-state Li-ion Batteries in which the organic liquid electrolyte is replaced by a ceramic electrolyte eliminate thermal management systems and allow use of lithium metal anodes, providing batteries with higher specific energy, as well as the ability to safely operate at higher temperatures. Current limitations impeding the development of solid-state batteries are related to poor interfacial behavior of the solid-state electrolyte with the electrode materials. The “solid-solid” interface leads to high interfacial resistance and poor charge transfer kinetics thus limiting the power output of the battery, with C-rates as low as C/100 at room temperature, which makes solid-state batteries non suitable for automotive application. Engineering secondary phase electrolyte interfaces is therefore key to enabling the development of high power all solid-state and hybrid Li-ion batteries.

The solid-state or hybrid battery disclosed herein is directed to overcoming one or more of the problems set forth above and/or other problems of the prior art.

### SUMMARY OF THE DISCLOSURE

Disclosed herein is a solid-state or hybrid battery comprising: a cathode-side and an anode-side; at least one electrolyte; at least one active material; and at least one composite electrode located on the cathode-side or the anode side, or both, wherein the composite electrode comprises a three-dimensional porous scaffold that exhibits ionic conductivity, electronic conductivity, or both, wherein the three-dimensional porous scaffold, electrolyte and active material are configured to provide ion and electron conductivity that enables electrochemically-active material loadings in excess of 2.5 mAh/cm².

In an embodiment, the three-dimensional composite electrode which has ionic conductivity, electronic conductivity, or both consists of a plurality of ion-conducting regimes and electron-conducting regimes.

### BRIEF DESCRIPTION OF THE DRAWINGS

An embodiment will now be described, by way of example only, with reference to the accompanying drawings, wherein:

FIG. 1A shows a graph demonstrating the high ionic conductivity of two doped solid-state electrolyte samples prepared by casting and sintering at 1000° C. a c-LLZO nanoparticle slurry, according to the present disclosure, having a D50 average nanoparticle size of 400 nanometers (nm);

FIG. 1B shows a charge-discharge curve of a solid state battery cell according to the present disclosure by infiltrating a nickel-manganese-cobalt (NMC) cathode material into a c-LLZO electrolyte scaffold and laminating a lithium metal anode onto it;

FIG. 2 shows one exemplary cylindrical cell monoblock and an enlarged view of the stack prepared using the solid-state electrolytes and arranged in a bipolar configuration according to the present disclosure and having a 14.8 Volt capacity;

FIG. 3A is a pie chart showing the relative distribution (in mass) of materials comprising a typical Li ion battery;

FIG. 3B is a pie chart showing the relative distribution (in mass) of materials comprising a Li-ion battery produced according to the present disclosure;

FIG. 4 is cross-sectional representation of the architecture of a unit cell of the solid-state battery according to the present disclosure;

FIG. 5 is a flow diagram showing an inventive process used in cell assembly of the batteries according to the present disclosure;

FIG. 6 is an inventive device used to insert materials into the three-dimensional porous scaffolds described in the present disclosure;

FIGS. 7A and 7B show comparisons between two liquid electrolyte formulations tested in symmetric Li—Li cell using a plastic separator. A) Poor cycle life electrolyte formulation cycling at C/5 and 2.5 mAh/cm² design capacity B) High cycle life electrolyte formulation cycling at C/2 and 2 mAh/cm² design capacity;

FIG. 8 is a Scanning Electron Microscope (SEM) image of a three-dimensional porous scaffold and dendrite-blocking separator, both produced from LLZO according to the present disclosure;

FIG. 9 is a graph showing potential (V) versus cell areal capacity (mAh/cm²) for a hybrid pouch cell according to the present disclosure;

FIG. 10 is a graph comparing two catholyte binder systems for a hybrid solid-state battery showing reduced interfacial resistance (consistent with enhanced electrode kinetics) measured by complex electrochemical impedance spectroscopy;

FIG. 11 is a schematic representation of a planarization jig used to produce three-dimensional composite scaffolds of precise thickness;

FIG. 12A is a complex electrochemical impedance spectroscopy (EIS) spectrum of the PEO separator obtained using a SS/PEO/SS blocking electrode conductivity cell at room temperature.

FIG. 12B displays the calculated room temperature Li⁺ ionic conductivity of thin PEO separators as a function of EO to Li⁺ molar ratio;

FIG. 13 displays a chronoamperogram recorded at an aluminum foil working electrode using a liquid electrolyte made of LiFSI and Sulfolane. The chronoamperogram demonstrates high anodic stability of the electrolyte up to 4.6 V vs Li⁺/Li⁰;

FIG. 14 is a schematic representation of carbon deposited inside of the pores of the three-dimensional composite scaffold;

FIG. 15A is a SEM micrograph of a carbon-coated c-LLZO bilayer showing a thin layer of conducting amorphous carbon deposited on the surface and within the pores of the porous c-LLZO scaffold;

FIG. 15B is an elemental mapping of carbon using energy dispersive X-ray spectroscopy on the c-LLZO bilayer showing successful carbon deposition;

FIG. 15C is a photograph of an as-prepared c-LLZO bilayer following calcination and containing a carbon coating within the porous scaffold;

FIG. 16 is an SEM micrograph of an of a microscopically-ordered porous ionically-conductive c-LLZO scaffold in contact with electrochemically-active LiNi_{0.6}Mn_{0.2}Co_{0.2}O₂. The dashed line highlights the interface between the ceramic electrolyte and the cathode active material;

FIG. 17 is a schematic representation of a heated uniaxial press to attach current collectors with a conductive thermoplastic adhesive;

FIG. 18 is a bar graph showing the through-plane resistance of various inventive thermoplastic electronically conductive current collectors;

FIG. 19 shows a schematic of a composite hybrid solid-state cell using adhesive current collector;

FIG. 20 displays a cell voltage profile as function of areal capacity (mAh/cm²) for a hybrid solid-state battery using a conductive binder within the cathode-infiltrated c-LLZO porous scaffold.

### DETAILED DESCRIPTION OF A PREFERRED EMBODIMENT

### Definitions

As used herein, the term “Anolyte” is intended to mean that portion of the electrolyte in the immediate vicinity of the electrode with lower electrochemical potential in an electrochemical cell including a battery cell, opposite to the electrode with higher electrochemical potential.

As used herein, the term “Catholyte” is intended to mean that portion of the electrolyte in the immediate vicinity of the electrode with higher electrochemical potential in an electrochemical cell including a battery cell, opposite to the electrode with lower electrochemical potential.

As used herein, the term “Electrolyte” is intended to mean a solid, liquid, or gel that contains mobile ions.

As used herein, the term “Solid electrolyte” is intended to mean a solid material (as opposed to a liquid or gel) that contains mobile ions. A solid-state battery typically encompasses battery technology that uses solid electrodes and a solid electrolyte, instead of liquid or gel electrolytes.

As used herein, the term “Bulk Density” is intended to mean, the mass of a divided solid, such as powders or particles, divided by the total volume they occupy. The total volume includes particle volume, inter-particle void volume, and internal pore volume. Bulk density can also be referred to as apparent density or volumetric density.

As used herein, the term “Dendrites” is intended to mean branching crystals that grow from an electroplated surface when the current passed is above the threshold where the reaction rate is governed purely by electrode kinetics.

As used herein, the term “Slurry” is intended to mean a mixture of solids suspended and/or dissolved in a liquid.

As used herein, the term “Solution” is intended to mean a liquid mixture comprising a minor component (the solute) that is uniformly distributed within a major component (the solvent).

As used herein, the term “Dispersion” is intended to mean the act of separating solids homogenously into a liquid.

As used herein, the term “Low-energy ball milling” is intended to mean a process whereby milling media is added to a slurry or solution, and the plurality is agitated by rotating around one or more axes but at a speed not sufficient to reduce the particle size of the solids or cause any chemical or mechanical distortion

As used herein, the term “High-energy ball milling” is intended to mean a process whereby milling media is added to a slurry or solution, and the plurality is agitated by rotating around one or more axes at a speed sufficient to reduce the particle size of the solids and/or cause chemical or mechanical distortion.

As used herein, a “Hybrid Electrode” is intended to mean a plurality of a solid-electrolyte scaffold and electrochemically-active material.

As used herein, the term “Shear mixing” is intended to mean dispersing or transporting one phase or ingredient into a main (and typically immiscible) continuous phase by causing one area of fluid to travel at a different velocity relative to an adjacent area.

As used herein, the term “LLZO” is intended to mean the cubic garnet-type structure Li₇La₃Zr₂O₁₂.

As used herein, the term “Emboss” is intended to mean putting patterns, typically raised patterns, on a material, such as fabric, by passing it through rollers with patterns.

As used herein, the term “Pore-former” is intended to mean a material used to fabricate a material with controlled or defined porosity, such as with distinct features including pore size, distribution and/or morphology.

As used herein, the term “Current collectors” is intended to mean the component of a battery that delivers electrons from to and from the electroactive materials

As used herein, the term “Wetting” is intended to mean the ability of a liquid to penetrate into and maintain contact with a porous surface.

As used herein, the term “Hybrid Electrode” is intended to mean an electrode containing a plurality of at least two of the following, solid electrolytes, gel electrolytes, and liquid electrolytes.

Disclosed herein is a solid-state or hybrid Li-ion battery comprising a ceramic, solid-state electrolyte having a lithium-conducting oxide composition selected from the group consisting of perovskite-type oxides, NASICON-structured lithium electrolytes, and garnet-type structures containing transition metal oxides and the manufacturing methods to make them. As is known in the art NASICON generally refers to sodium super ionic conductors. As known to those of skill in the art a perovskite is any material with the same type of crystal structure as calcium titanium oxide (CaTiO3). They have the general chemical formula of ABX3, wherein A and B are cations having very different sizes from each other and X is an anion that binds to both A and B.

Per one aspect of the invention, the NASICON-structured lithium electrolytes comprise LiM2(PO4)3, where M=Ti, Zr, or Ge.

Per another aspect, garnet-type structures containing transition metal oxides and the manufacturing methods to make them. As is known in the art NASICON generally refers to sodium super ionic conductors. As known to those of skill in the art a perovskite is any material with the same type of crystal structure as calcium titanium oxide (CaTiO₃). They have the general chemical formula of ABX₃, wherein A and B are cations having very different sizes from each other and X is an anion that binds to both A and B.

Per one aspect of the invention, the NASICON-structured lithium electrolytes comprise LiM₂(PO₄)₃, where M=Ti, Zr, or Ge.

Per another aspect, the garnet-type structures containing transition metal oxides comprise Li₇La₃M₂O₁₂, where M=a transition metal.

According to another aspect of the invention, the garnet-type structures containing transition metal oxides comprise amorphous LiPON or LiSi—CON.

Per still another aspect, the garnet-type structures containing transition metal oxides comprise lithium ion-conducting sulfides selected from the group consisting of Li₂S—P₂S₅ glass, Li₂S—P₂S₅—Li₄SiO₄ glass, Li₂S—SiS₂ glass, Li₂S—Ga₂S₃—GeS₂ glass, Li₂S—Sb₂S₃—GeS₂ glass, Li₂S—GeS₂—P₂S₅ glass, Li₁₀GeP₂S₁₂ glass, L₁₀SnP₂S₁₂ glass, Li₂S—SnS₂—As₂S₅ glass, and Li₂S—SnS₂—As₂S₅ glass-ceramic.

In one embodiment, the precursor ceramic nanoparticle powder has a composition with a general formula ABO₃ with “A” representing an alkaline or rare earth metal ion and “B” representing a transition metal ion, e.g. Li₃ₓLa_{2/3x}TiO₃ (perovskite).

In another embodiment, the precursor nanoparticle compounds have a general formula of AM₂(PO₄)₃ where “A” represents an alkali metal ion (Li⁺, Na⁺, K⁺) and “M” represents a tetravalent metal ion (Ge⁴⁺, Ti⁴⁺, Zr⁴⁺), e.g. Li_{1.5}Al_{0.5}Ge_{1.5}(PO₄)₃ (NASICON).

In another embodiment, the precursor nanoparticle compounds have a general formula Li₇A₃B₂O₁₂ where “A” represents an eight coordination cation and “B” represents a six coordination cation, e.g. Li₇La₃Zr₂O₁₂ (garnet). Ionic conductivity of these materials could be further enhanced by substitution of “A” cations with Ta, Nb, Al, Ga, In or Te and substitution of “B” cations with Y, Ca, Ba, Sr.

Per yet another feature, the solid-state electrolyte may be a metal substituted c-LLZO with a general formula of Li₇La₍₃₋ₓ₎MₓZr₂O₁₂ (garnet), wherein the metal M is selected from the group but not limited to Al, Ga, Ta, W, and elements in group III and IV of the periodic table and wherein “x” has a value of from 0 to 3, thus x can be a whole number or any fraction thereof.

Per yet another feature, the solid-state electrolyte may be a metal substituted c-LLZO with a general formula of Li₇La₃Zr₍₂₋ₓ₎MxO₁₂ (garnet), wherein the metal M is selected from the group but not limited to Sc, Y, Ti, or another transition meta I and x can have any value from 0 to 2. In yet another embodiment, the precursor materials are crystalline or amorphous nanoparticles of solid sulfide-based electrolytes, such as those of the Li₂S—SiS system or those having compositions of the format Li₄₋ₓGe₃ₓ PₓS₄, where x is a number between 0 and 1.

In certain embodiments of the present invention the anode, cathode or electrolyte material can be formed into a film and the films can include a thin-film coating interfacial layer applied to their surface before or after sintering and interfacing one or all of the individual layers. This facilitates lithium ionic mobility between layers and reduces or prevents layer-to-layer contact resistance, a hindrance that typically plagues solid state lithium batteries. Moreover, such an interfacial layer may prevent anode, cathode and electrolyte material interdiffusion and promote adhesion between layers of dissimilar composition, crystal structure and mechanical properties. Suitable materials for such a buffer layer may be selected from, without limitation, compounds from the group including Li₂O, B₂O₃, WO₃, SiO₂, Li₃PO₄, P₂O₅, Fe₃(PO₄)₂, Co₃(PO₄)₂, Ni₃(PO₄)₂, Mn₃(PO₄)₂ and mixtures thereof.

In yet another embodiment the thin-film coating interfacial layer applied to anode, cathode or electrolyte layers consists of a polymeric material or a polymer electrolyte material based on a material selected from the group consisting of polyethylene oxide (PEO), poly(vinyl alcohol) (PVA), aramids, and polyaramid polyparaphenylene terephthalamide.

Any of the solid-state electrolyte precursor nanoparticles or the sintered film, the cathode precursor nanoparticles or the sintered film, and the anode precursor nanoparticles or the sintered film may be infiltrated or pre-coated with, respectively, an intermediate phase between the electrolyte and a secondary or tertiary compound, a catholyte, or an anolyte selected from, without limitation, the group consisting of Li, Li₂O, B₂O₃, WO₃, SiO₂, Li₃PO₄, P₂O₅, Fe₃(PO₄)₂, Co₃(PO₄)₂, Ni₃(PO₄)₂, Mn₃(PO₄)₂, lithium phosphorous oxy-nitride (“LiPON”) and LaTiO₃.

In yet another embodiment the electrolyte film prepared according to the present disclosure includes a polymer coating applied after sintering and before anode or cathode layers are bonded to the electrolyte or the electrolyte scaffold.

According to yet a further feature, Li is melt-infiltrated or electrodeposited into the solid-state electrolyte prepared according to the present disclosure. Further embodiments comprise a composite electrolyte film with lithium infiltrated between the composite grains or as an intermediate electrolyte phase acting as an anolyte or a catholyte infiltrated in between the composite grains or the active material grains, e.g. in the cathode. Such an intermediate electrolyte phase comprises at least two components resulting from the reaction of the lithium or the cathode materials with the electrolyte forming a binary or tertiary intermediate phase.

In yet another embodiment a lithium or lithium alloy ribbon, foil or other suitable metallic film form is laminated onto the electrolyte layer to form the anode. Between the electrolyte and the metallic lithium anode there may be an intermediate layer interposed made of, but not limited to, compounds from the group including Li₂O, B₂O₃, WO₃, SiO₂, Li₃PO₄, P₂O₅, Fe₃(PO₄)₂, Co₃(PO₄)₂, Ni₃(PO₄)₂, Mn₃(PO₄)₂ and mixtures thereof.

In yet another embodiment the thin-film intermediate layer consists of a polymeric material or a polymer electrolyte material based on a material selected from the group consisting of PEO, PVA, aramids, and polyaramid polyparaphenylene terephthalamide.

Per yet another form, the solid-state electrolyte may be a metal substituted c-LLZO with a general formula of Li₇La₍₃₋ₓ₎MₓZr₂O₁₂ (garnet), wherein the metal M is selected from the group but not limited to Al, Ga, Ta, W, and elements in group III and IV of the periodic table and wherein x has a value of from 0 to 3.

Per yet another form, the solid-state electrolyte may be a metal substituted c-LLZO with a general formula of Li₇La₃Zr₍₂₋ₓ₎MₓO₁₂ (garnet), wherein the metal M is selected from the group but not limited to Sc, Y, Ti, and another transition metal and wherein x has a value of from 0 to 2.

In one form, the battery designed according to the present disclosure may be a 12V (nominal voltage) LIB made with such electrolytes, wherein the electrolytes are made using scalable casting and sintering methods based on metal-oxide nanoparticle powders. More specifically, the solid-state electrolyte membranes (e.g. <30 μm thick) may be fabricated using nanoparticle powders that have sizes ranging from 20-900 nanometers synthesized by flame-spray pyrolysis, co-precipitation or other solid-state or wet chemistry nanoparticle (“NPs”) fabrication routes.

Nanoparticles that can be used for the invention can be synthesized by any of a variety of methods including, without limitation, plasma spray, ultrasonic assist spray synthesis, fluidized bed reaction, atomic layer deposition (ALD) assisted synthesis, direct laser writing (DLW), chemical vapor deposition (CVD), low pressure chemical vapor deposition (LPCVD), microwave plasma enhanced chemical vapor deposition (NPECVD), pulsed laser deposition (PLD), physical vapor deposition (PVD), gas phase decomposition, detonation, flame spray pyrolysis, co-precipitation, sol-gel synthesis, sol-gel dipping, spinning or sintering. As described, they preferably have an average particle size of from 20 to 900 nm, more preferably from 200 to 600 nm.

The nanoparticles that can be used for preparing the solid-state electrolytes according to the present disclosure in certain embodiments can be coated, treated at the surface or throughout the bulk or in any open porosity by one or multiple layers of solid electrolyte materials or intermediate phases between solid electrolyte and anode or cathode active materials, e.g. a catholyte or anolyte suitable compound using one or more sequential deposition processes selected from, without limitation, plasma treatment, ultrasonic assist spray, fluidized bed reaction, atomic layer deposition (ALD), direct laser writing (DLW), chemical vapor deposition (CVD), low pressure chemical vapor deposition (LPCVD), microwave plasma enhanced chemical vapor deposition (NPECVD), pulsed laser deposition (PLD), physical vapor deposition (PVD), gas phase decomposition, detonation, flame spray pyrolysis, co-precipitation, sol-gel synthesis, sol-gel dipping, spinning or sintering, sputtering, radio frequency magnetron sputtering, nanoimprint, ion implantation, laser ablation, spray deposition.

It is preferred, but not strictly necessary, to start with nanoparticles having a spherical aspect ratio and bell-shaped size distributions that improve the packing density of the green films formed and result in lower sintering temperatures with final film densities above 95% for incorporation into a LIB design.

Suitable precursor nanoparticle materials include, for instance, ionic conductors with garnet, olivine, perovskite, or NASICON crystal structures, or sulfide or phosphate based glasses and having enhanced ionic conductivities, e.g. c-LLZO or lithium phosphate as described herein.

In one embodiment, the precursor ceramic nanoparticle powder has a composition with a general formula ABO₃ with “A” representing an alkaline or rare earth metal ion and “B” representing a transition metal ion, e.g. Li₃ₓLa_{2/3x}TiO₃ with a perovskite type oxide structure.

In another embodiment, the precursor compounds have a general formula of AM₂(PO₄)₃ where “A” represents an alkali metal ion (Li⁺, Na⁺, K⁺) and “M” represents a tetravalent metal ion (Ge⁴⁺, Ti⁴⁺, Zr⁴⁺), e.g. Li_{1.5}Al_{0.5}Ge_{1.5}(PO₄)₃ (NASICON structured lithium electrolyte).

In another embodiment, the precursor compounds have a general formula Li₇A₃B₂O₁₂ where “A” represents an eight coordination cation and “B” represents a six coordination cation, e.g. Li₇La₃Zr₂O₁₂, a garnet type structure including a transition metal oxide. Ionic conductivity of these materials could be further enhanced by substitution of “A” cations with Ta, Nb, Al, Ga, In or Te and substitution of “B” cations with Y, Ca, Ba, Sr.

In yet another embodiment, the precursor materials are crystalline or amorphous nanoparticles of solid sulfide-based electrolytes, such as those of the Li₂S—SiS system or those having compositions of the format Li₄₋ₓGe₁₋ₓPₓS₄, where x has a value between 0 and 1.

The batteries produced using the approaches disclosed in the present invention will have superior performance to any of the existing lithium ion or other battery chemistries. In particular the batteries produced with the methods disclosed herein will have gravimetric energy density between 350 and 650 Wh/kg and will also have volumetric energy density between 750 and 1,200 Wh/L.

The anode, cathode or electrolyte films may include a thin-film coating interface layer applied to their surface before or after sintering and interfacing one or all of the individual layers. This facilitates Lithium ionic mobility between layers and reduces or prevents layer-to-layer contact resistance, a hindrance that typically plagues solid-state lithium batteries. Moreover, such an interface layer may prevent anode, cathode and electrolyte materials interdiffusion and promote adhesion between layers of dissimilar composition, crystal structure and mechanical properties. Suitable materials for such a interface layer may be selected from, without limitation, compounds from the group including Li₂O, B₂O₃, WO₃, SiO₂, Li₃PO₄, P₂O₅, Fe₃(PO₄)₂, CO₃(PO₄)₂, Ni₃(PO₄)₂, Mn₃(PO₄)₂, and mixtures thereof.

Per a still further feature, the solid-state electrolyte includes a lithium phosphorous oxy-nitride (“LiPON”) coating applied to the surface of the films pre-sintering or, alternatively, after sintering and before calandering.

The present invention also comprehends several avenues to improve c-LLZO films to enable Li cycling without shorting, to generate solid ion conductors that can prevent dendrite growth, self-discharge, and to promote safety, power and cycle life.

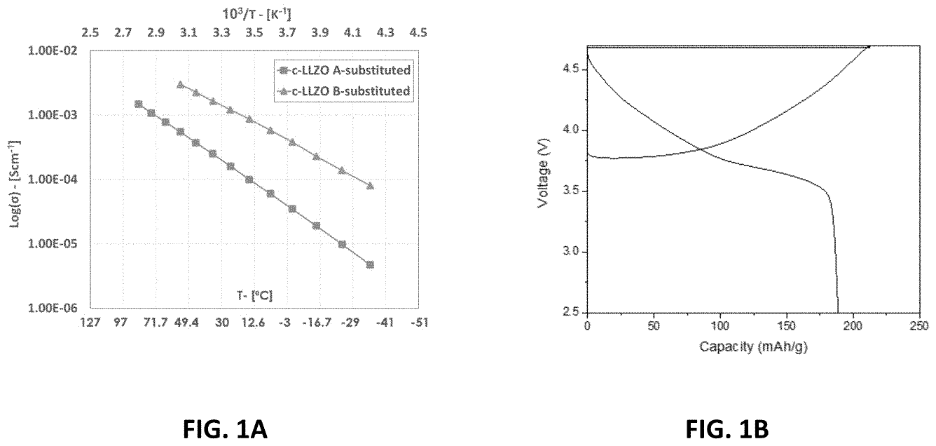

Hybrid solid-state ion conductors, e.g. newly-developed c-LLZO combined with high energy density cathodes and Li anodes according to the present disclosure represent innovations that remove the tradeoffs between energy and cycle life. Novel, composite c-Li₇La₃Zr₂O₁₂ ion-conducting solid-state films made by freeze-casting and low-pressure-sintering of nanoparticles according to the present disclosure can overcome most of the existing technical gaps in solid-state electrolytes and can attain ionic conductivities comparable to liquid electrolytes see FIG. 1A. As shown in FIG. 1A freeze cast films sintered according to the present invention show significant conductivity even at temperatures below 0° C. and even below −30° C. The A-substituted film was formed from Li₇La₃₋ₓMₓZr₂O₁₂ wherein M was aluminum; the B-substituted film was formed using gallium as the metal. These materials prepared according to the present disclosure are uniform, thin 30 μm, 95+% dense with Li+ conductivity comparable to traditional ICMs with liquid electrolytes. The slope of the curves is constant and linear, prior art systems demonstrate a hockey stick shaped curve wherein the conductivity at temperatures of 0° C. or lower are equal to nearly 0. In addition other solid-state electrolyte materials, well-known in the field of thin-film batteries, are costly, produced through unscalable techniques and difficult to integrate in existing battery systems. FIG. 1B demonstrates the benefits of solid-state ionic conductors according to the present disclosure like the ones reported in FIG. 1A when integrated into a full solid-state battery cell system constructed using freeze casting methods outlined in the present invention. The cell was constructed by infiltrating a nickel-manganese-cobalt (NMC) cathode material into an LLZO scaffold and laminating a lithium metal anode onto it. The curve shows high initial and midpoint voltages that represent low internal resistance and high specific capacity of greater than 170 mAh per gram of active material (i.e. NMC).

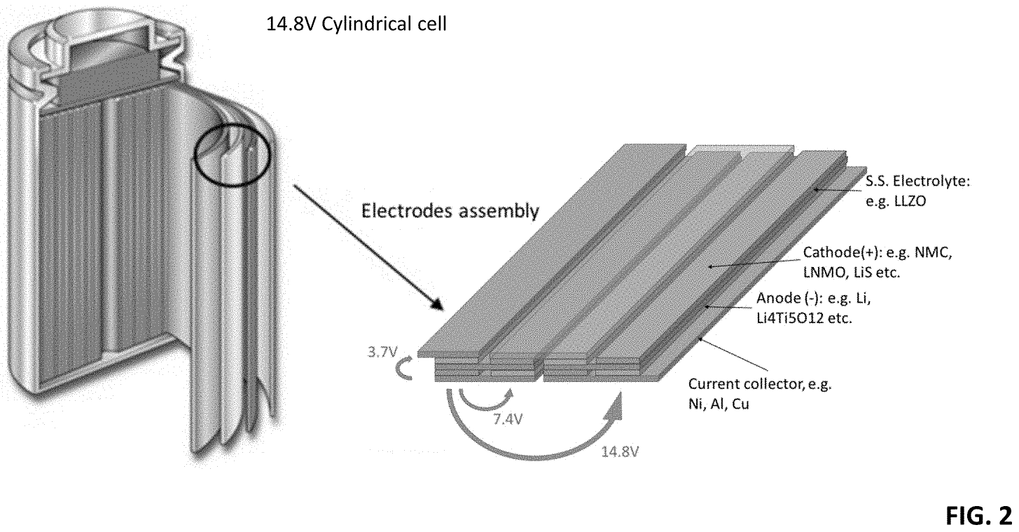

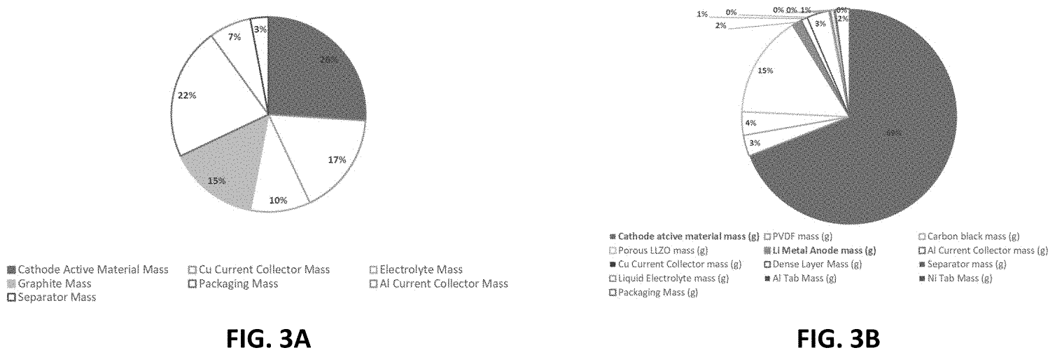

FIG. 2 shows one exemplary cylindrical cell monoblock and an enlarged view of the stack prepared using the solid-state electrolytes according to the present disclosure and having a 14.8Volt voltage. The cathode can be formed from a nickel-manganese-cobalt (NMC) compound, LNMO, LiS and other known materials. The solid-state electrolyte such as a c-LLZO is shown located between the cathode and the anode. The cell monoblock consists of four 3.7 V cells situated in series. The stack is jelly rolled to form the cylindrical cell as shown.

The present invention comprehends fabricating electrolyte/anode composite layers as an alternative approach to increase interfacial areas in order to reduce the interfacial resistance on the cathode side.

The present invention comprehends several avenues to either mechanically block Li dendrites or maximize distribution of the Li+ current by increasing Li/electrolyte interfacial areas to enhance tolerable current densities with a target performance >2.5 mA/cm² at ambient temperature.

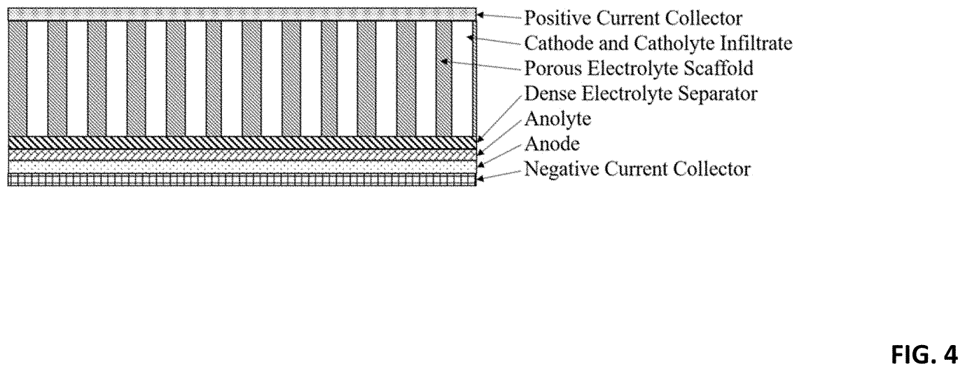

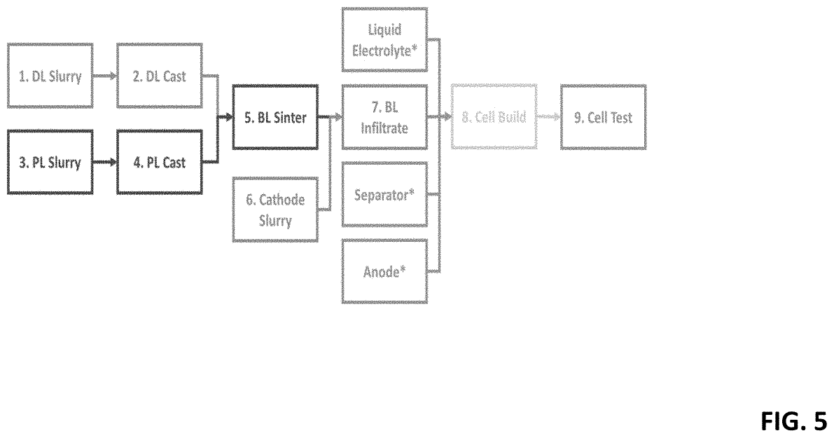

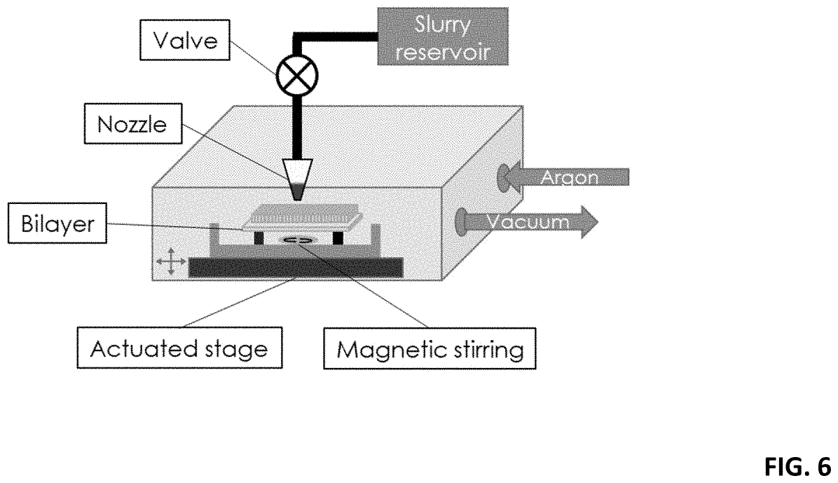

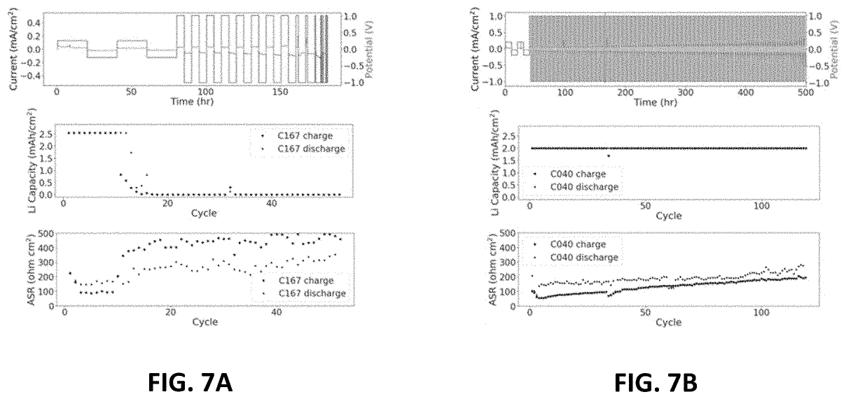

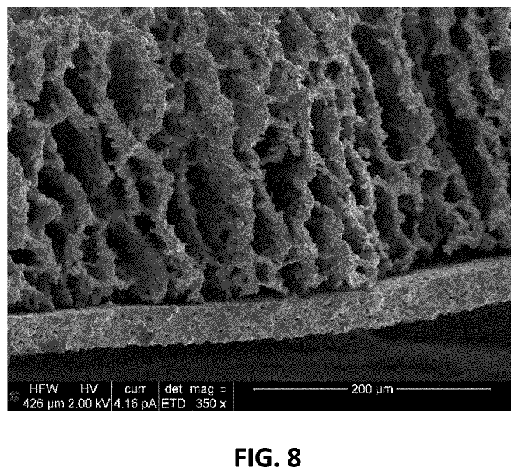

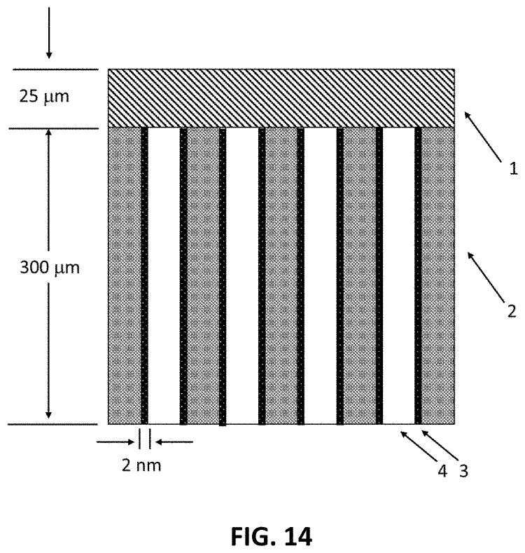

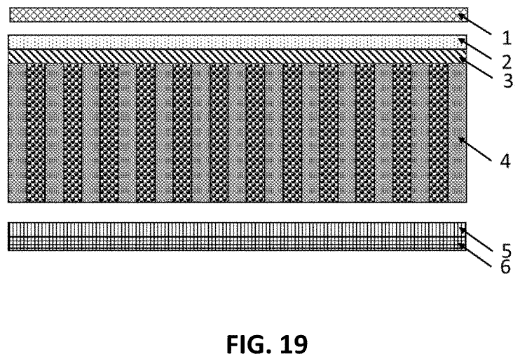

As discussed above, thin film LIBs have successfully cycled at practical levels. However, the cathode layer is only several tens of μm thick, limiting the attainable energy density. For bulk battery systems, thicker (several hundreds of μm) cathode layers are required. The present invention comprehends cathode/electrolyte or anode/electrolyte composite layers formed by infiltrating cathode or anode active materials into the solid-state electrolyte scaffolds to maximize the utilization of the active materials (cathode and anode) and to accelerate the ionic and electronic conductance on charge/discharge. See FIG. 4, FIG. 14 and FIG. 19 which show schematic figures of such structures.

Among other features, the present invention comprehends:purchasing from commercial suppliers nanoparticles of c-LLZO or other solid-state electrolytes and Li(NxMyCz)O₂ cathode materials, with x+y+z=1, x:y:z=4:3:3 (NMC433), 5:3:2 (NMC532), 6:2:2 (NMC622), and 8:1:1 (NMC811) cathode NPs or using one of the described high-throughput methods to synthesizing these NPs materials at rates higher than 100 g/h.

In addition, using polymer-derived interfacial coatings based on LiSiOₓ, LiPON and LiBOₓ for these fabricated layers.

Such all-solid-state LIBs as disclosed hereinabove eliminate thermal management systems and allow use of Li-metal anodes, providing batteries with higher volumetric/gravimetric energy densities, as well as the ability to safely operate at higher temperatures with faster charge/discharge rates that enable further flexibility in LIB designs.

### Composite Cathode Physical Properties

In one embodiment, there is disclosed composite cathodes having at least one unique chemical, mechanical or physical make-up. For example, the solid-state or hybrid battery electrode disclosed herein has a thickness that is substantially greater than the current state of the art slurry-cast electrodes. In general, the methods described herein are effective at producing composite electrode thicknesses of >100 μm. Of particular interest are electrodes with thicknesses in the range of 200-500 μm which provides a good balance between energy and power.

Included in the present disclosure are the requirements that in order for the electrochemically-active materials to be fully-utilized in a solid-state or hybrid battery cell with an energy density in the range of 350-500 Wh/kg, an electrical conductivity greater than 1E-1 S/m and ionic conductivity greater than 1E-4 S/m are required. Provided the steps in this disclosure are followed by someone skilled in the art, energy density, electronic conductivity and ionic conductivity can all be achieved.

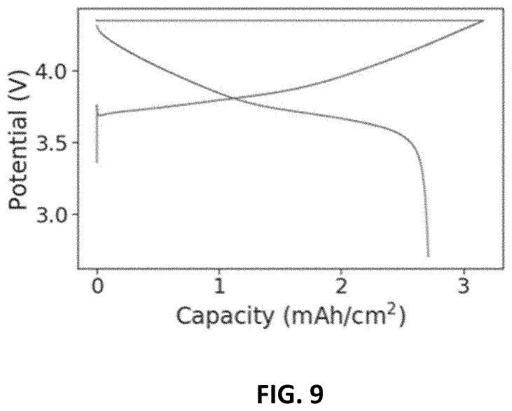

The present invention also describes methods that enable electrode loadings in excess of 2.5 mAh/cm2 as shown in FIG. 9, in some cases greater than 5 mAh/cm2 and even in excess of 8 mAh/cm2.

In order to have a high gravimetric and volumetric energy density in the invention described herein, the maximization of porosity of the three-dimensional solid-state or hybrid scaffold is desired and is accompanied with the minimization of the inter-particle porosity of the cathode. The reason for this is to minimize the fraction of non-electrochemically active materials, with the inter-particle porosity of the cathode becoming filled with non-electrochemically active liquid in the realized hybrid device. The solid-state or hybrid cell disclosed herein describes steps to obtain a three-dimensional solid-state or hybrid electrolyte scaffold ceramic electrolyte with porosity in excess of 30% that houses electrochemically active materials with a porosity of less than 30%. In one embodiment, the three-dimensional solid-state or hybrid electrolyte scaffold has a porosity of greater than 60% and more typically 85% and the electrochemically active materials that are housed within it have a porosity less than 30% and more typically 15-20%.

### Cathode Electrical and Ionic Conductivity

Further disclosed are methods and materials to produce a composite cathode structure whereby the cathode electronic conductivity exceeds 1E-1 S/m. In the exemplary description of this invention, conductivity in excess of 5E-1 S/m is achieved on as-cast slurries through modulating the slurry solvent, solids loading, conductive additive loading and conductive additive type.

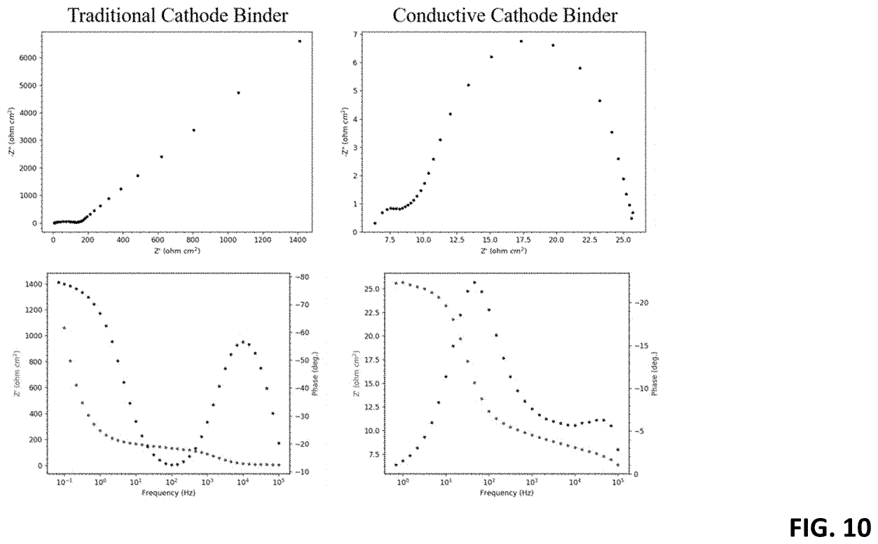

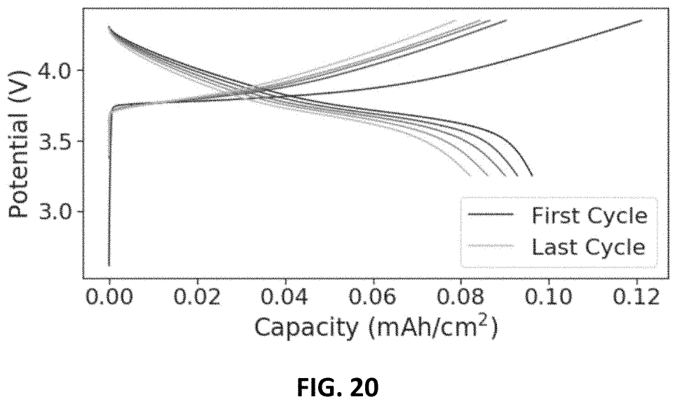

In various embodiments, a number of conductive additives can be used to enhance the electrical conductivity of the composite electrodes disclosed within, as depicted in FIG. 10 and in FIG. 20. The requirements for selection of conductive additives include but are not limited to: 1) electrochemical compatibility, 2) chemical compatibility, 3) ability to be dispersed within the electrochemically active materials enough to percolate electrons efficiently, 3) higher electronic conductivity than the electrochemically-active materials.

In one embodiment, materials from the carbon family are chosen to meet the foregoing properties. These include but are not limited to carbons from the families of carbon black, vapor-grown nanofibers, graphite, mesocarbon microbeads (MCMB), nanocrystalline graphite, single-wall carbon nanotubes, double-wall carbon nanotubes, multi-wall carbon nanotubes, carbon fullerenes, carbon nanodiamond, polymers from the families including but not limited to polyaniline, polypyrrole, polyacetylene, polythiophene, poly(3,4-ethylenedioxythiophene), poly(p-phenyl sulfide), poly(p-phenylene vinylene) and a number of conductive metal oxides including but not limited to WO3, ReO2, RuO2, IrO2, TiB2, MoSi2, n-BaTiO3, CrO2, TiO2, ReO3, and combinations thereof.

As a further embodiment of the invention disclosed herein, the conductive polymer can be polymerized within the porous network of the composite electrode. As an additional embodiment, aniline can be electrochemically oxidized in-situ to polyaniline inside of the porous structure of the composite cathode structure. This is also true for a number of other conductive polymers such as polythiophene, or polypyrrole which can be electrochemically or chemically oxidized to their conductive polymeric forms. As a particularly exemplary embodiment, conductive polymers can be polymerized in-situ during operation of the battery through proper selection of liquid electrolyte additives.

An additional embodiment of the present disclosure is the use of polymers with both ionically conductive and electronically conductive domains. One particular embodiment of the present invention is the use of poly-4-vinylpyridine (P4VP) polymers as binders in the cathode material slurry. P4VP is a polymer of interest due to its high electrical conductivity, though it suffers from low thermal and mechanical stability. FIG. 20 shows the results of a LLZO porous scaffold hybrid-cell infiltrated with low loading of NMC 622 cathode with 5% P4VP binder and a Li-metal anode and a standard carbonate-based electrolyte.

As a further disclosure, electronic conductivity can be added to the composite electrodes, which for the sake of this disclosure can be described as the plurality of the three-dimensional solid-state or hybrid scaffold, the electrochemically-active electrode material, and any additional binders, and ionically and/or electronically conductive additives or coatings by using a conductive coating within the scaffold porosity. As an exemplary example, electrical conductivity can be added to porous Al-doped LLZO by depositing carbon on the surface.

Three general methods of carbon deposition are disclosed herein which can be generally grouped into catalytic hydrocarbon gas decomposition, organic compound decomposition and thermal oxidation of polyacrylonitrile. Numerous routes can be utilized to produce the desired conductive carbon that would be obvious to someone skilled in the art and the exemplary embodiments are disclosed herein.

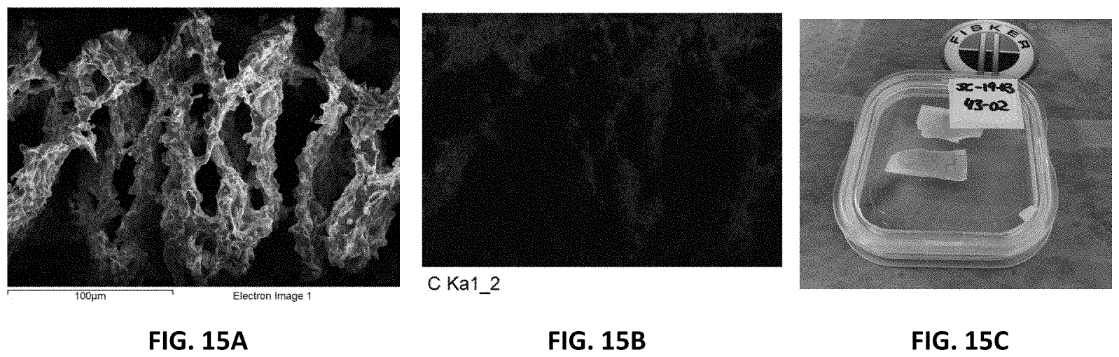

In the first general embodiment, a dilute solution of sucrose, an organic compound, typically in the range of 1 wt. % to 20 wt. % and more typically 5 wt. %, is produced in a solvent, then introduced into the pores of the three-dimensional solid-state or hybrid scaffold. This can be accomplished by any number of techniques, with the simplest being the use of a pipette or similar. The solution is then evaporated by heating at a temperature in the range of 50° C. to 100° C. to produce a coating of the organic compound, in this case sucrose, on the surface of the pore walls of the three-dimensional solid-state or hybrid scaffold. The coated three-dimensional solid-state or hybrid scaffold is then placed into an oven containing an inert atmosphere and heated to a temperature of 400° C. to 900° C. which causes decomposition of the organic compound into an amorphous carbon that provides electronic conductivity while still enabling access of lithium ions to the ionically-conducting three-dimensional solid-state or hybrid scaffold. FIG. 15A shows a SEM micrograph of one particular example of this embodiment. FIG. 15B shows an elemental mapping of carbon using energy dispersive X-ray spectroscopy on the c-LLZO bilayer showing successful carbon deposition.

In the second general embodiment, a hydrocarbon gas is introduced into an environment that contains the three-dimensional solid-state or hybrid scaffold at a temperature above the temperature where the hydrocarbon gas is thermodynamically stable. In general, these temperatures are greater than 400° C. Numerous materials disclosed herein that comprise the three-dimensional solid-state or hybrid scaffold are catalytic to growing low dimensionality (zero-dimensional, one-dimensional and/or two-dimensional) carbon nanostructures at a temperature in the range of 500° C. to 900° C. An additional and exemplary embodiment of this disclosure is the purposeful inclusion of carbonization catalysts that both encourage the growth of highly conductive and low dimensionality carbon nanostructures and become incorporated into the crystal lattice on the lithium site of LLZO, which reduces the effects of high temperature lithium loss and encourages the stabilization of the cubic phase of LLZO. One choice for this would be iron. Additionally, as an exemplary example of the present disclosure 2.5% acetylene in 97.5% argon when used as the precursor gas with iron oxide nanoparticles with diameter in the range of 1 nm to 100 nm, such as 5 nm at a temperature of 600° C. results in a structure with facile electron and ion transport.

In the third embodiment carbon-forming polymers such as polyacrylonitrile (PAN) or poly(1,3-diethnylbenzene) (PAB), which is used as a carbon fiber precursor, is introduced into the pores of the tree-dimensional solid-state or hybrid scaffold through either solution deposition, as was previously disclosed for the embodiment concerning organic material decomposition, or through direct polymerization of acrylonitrile monomers using a radical initiator. The polyacrylonitrile is then slowly heated to 400° C. to carbonize the polyacrylonitrile. As an additional embodiment, the polyacrylonitrile can be further graphitized to increase the electronic conductivity by heating to temperatures of approximately 1000° C. As described previously for hydrocarbon gas decomposition, iron can be advantageously added to reduce the temperature at which carbon graphitizes or becomes low dimensional structures in the form of iron oxide nanoparticles, or, in the case of polyacrylonitrile, a metal organic compound containing iron such as ferrocene.

In one of the present embodiments of the disclosed invention, a solid and fully-dense separator of LLZO with a thickness in the range of 1 μm to 100 μm, such as 15 μm is thermally sintered to a porous LLZO film with a thickness in the range of 50 μm to 1,000 μm, such as 300 μm to 500 μm and porosity in the range of 50% to 95%.

Further embodiments include the removal any carbon that becomes deposited on the dense LLZO separator to prevent electrical shorting of the positive electrochemically active material to the negative electrochemically active material. This is achieved through a number of methods, though the most exemplary methods disclosed here include but are not limited to using pulsed laser ablation, mechanical ablation, sanding, lapping, polishing, sandblasting, use of a water jet or combinations thereof.

### Electrochemically-Active Material Slurry

In the present disclosure, the manufacture of a high-quality slurry from electrochemically-active materials is essential to delivering high performance. There needs to be excellent fluidization of all components in order to ensure complete dispersion and homogenous mixing. These slurries are similar to traditional but state of the art lithium ion battery slurries in that they contain a plurality of active material, binder, conductive additive and other additives that provide functionality in some solvent. The identity of the solvent, ratio of the constituent parts and addition of alternative additives is novel, however. In general, the active material slurry contains 60-95 wt. % electrochemically active material, 1-20 wt. % conductive additive, 1-20 wt. % binder and a solvent with solids loading in the range of 5% to 40%.

According to a further aspect, the slurry comprises the one or more electrochemically-active materials, selected depending on the balance of energy, power, lifetime, cost or other considerations desired, the solvent or mixtures of solvent, the binder or combination of binders, the conductive additives, as well in some embodiments solid-state, polymer, liquid, or gel electrolyte components. The total solids loadings of is typically greater than about 55% and less than about 70% and more typically the total solids loadings are from about 10% to about 40%.

Per another feature of the disclosure, the slurry suspension has a nanopowder concentration greater than or equal to about 1 vol % to less than or equal to about 70 vol. % and that nanopowder can be a plurality of but not limited to solid electrolyte powder, electrochemically active materials, inorganic fillers, or combinations thereof

In general, different approaches are suggested to reduce agglomeration of the electrochemically-active material slurries. These include but are not limited to ultrasonication, high shear mixing, and high speed mixing. Additionally, other methods are employed to alter the surface chemistry of the materials to improve their dispersion. This can be done either chemically (functionalization or coating) or non-chemically using adsorption. Generally, surfactants that contain but are not limited to hydrophilic polyethylene oxide chains, aromatic hydrocarbon groups, polyethylene glycol chains, polyethers, oleic acid and sodium dodecyl sulfate (SDS) are utilized for the latter. Exemplary solvents consist of dimethylformamide (DMF), n-methyl-pyrrolidone (NMP), cyclohexyl-2-pyrrolidone (CHP), chloroform, toluene, aniline, dimethyl acetamide (DMAc), isopropanol, cyclopentanone, acetone, trichlorethylene, water, gamma-butyrolactone, hexamethylphosphoramide, tetrahydrofuran, nitromethane, pyridine, triethylamine, and combinations thereof

Generally, an embodiment provides at least one solvent containing conjugated carbon ring structures and amine functionality.

In an additional embodiment of the present disclosure, electrochemically-active materials can be used as the three-dimensional ionically and/or electronically conductive scaffold that can be subsequently used as-is with a liquid-, polymer-, gel-, or solid-electrolyte, or have further functionality added such as enhanced conductivity as described elsewhere herein. To achieve this, the methods described elsewhere for producing the three-dimensional ionically and/or electronically conductive hybrid or solid-state scaffold can be utilized. A further step of sintering could be used to improve the inter particle connection in such a three-dimensional and electrochemically active scaffold, though this technique is not necessarily compatible with all electrochemically-active electrode materials. In one embodiment of this, binders of the family including but not limited to poly(ethylene oxide) poly(vinylidene fluoride), styrene-co-butadiene, and poly(ethylene carbonate), would enable the 3-dimensional electrochemically-active scaffold to be used without sintering, enabling a host of other electrochemically-active cathode materials. As an additional embodiment, the last method disclosed could also involve casting directly onto the current collector.

It is to be recognized that different combinations of electrochemically-active cathode materials, electrochemically-active anode materials, and solid, liquid, polymer or gel electrolytes can be used to provide a different suite of desired performances. For example, in one embodiment, if high power and high cycle lifetime are desired, a cathode slurry containing a material of the olivine or sulfide family, an anode of the titanate family and a suitable solid-state electrolyte, hybrid-electrolyte, polymer-electrolyte, gel electrolyte, or combinations thereof can be used in conjunction with the three-dimensional ionically and/or electronically conductive solid-state or hybrid scaffold.

As a further embodiment, if high power and high cycle lifetime are desired, a cathode slurry containing a material of the NMC family, a lithium metal anode and a suitable electrolyte can be used in conjunction with the three-dimensional ionically and/or electronically conductive solid-state or hybrid scaffold. If high operation temperatures are desired, utilizing lithium iron phosphate in the cathode, lithium titanate in the anode and a solid polymer electrolyte consisting of polyethylene oxide with a salt of the family lithium bis(fluorosulfonyl)imide can be successfully used.

In addition, if there is reason to do so by someone skilled in the art, additional cathode materials can be considered, including but not limited to the lithium-containing oxides of lithium cobalt oxide, lithium manganese oxide, lithium nickel oxide, lithium nickel cobalt manganese oxide, lithium nickel cobalt aluminum oxide, lithium nickel manganese oxide, lithium titanium oxide, the lithium-containing silicates including but not limited to lithium iron silicate, the lithium-containing phosphates including but not limited to lithium iron phosphate, lithium cobalt phosphate, combinations thereof.

In addition, if there is reason to do so by someone skilled in the art, additional anode materials can be considered, including but not limited to graphite, silicon, tin, antimony, magnesium, aluminum, and combinations thereof.

### Porous Layer Morphology and Properties

Further disclosed are desired morphologies and materials required of the three dimensional ionically and/or electronically conductive solid-electrolyte or hybrid scaffold to enable complete utilization of the electrochemically-active materials at discharge rates in excess of full discharge over 3 hours and more typically a full discharge in 0.25 hours.

In some embodiments, the three-dimensional ionically and/or electronically conductive solid-electrolyte or hybrid scaffold is a gel.

In still further embodiments, the three-dimensional ionically and/or electronically conductive solid state or hybrid scaffold is purposefully designed to be a different state of matter under different fabrication temperatures and pressures and operational temperatures and pressures.

According to yet another feature, the three-dimensional structure of the three-dimensional ionically and/or electronically conductive solid state or hybrid scaffold is characterized by a thickness of no less than about 50 μm and no greater than about 500 μm, typically of no less than about 300 μm and no greater than about 500 μm.

According to still another feature, the pores of the three-dimensional ionically and/or electronically conductive solid state or hybrid scaffold have an acicular or elliptical structure with a long axis of 10 μm-1000 μm and a short axis of 1 μm to 20 μm.

As an additional feature to the disclosed invention, the ionically conductive materials selected for the three-dimensional ionically and/or electronically conductive solid-state or hybrid scaffold can come from the class of solid ceramic electrolyte materials, either used individually or in combination, of but not limited to garnet materials, perovskites, anti-perovskites, lithium-containing halide materials, LISICON-type structures, argyondite materials, and combinations thereof.

As a particular embodiment to the disclosed invention, the ionically conductive ceramic material selected for the three-dimensional ionically and/or electronically conductive solid-state or hybrid scaffold comes from the class of lithium garnets (LLZO) with the chemical formula Li7La3Zr2O12.

As a further embodiment to the disclosed invention, the ionically conductive ceramic material selected for the three-dimensional ionically and/or electronically conductive solid-state or hybrid electrolyte scaffold come from the class of doped lithium garnets with the chemical formula Li7-2xAxLa3Zr2O12. In this embodiment, A is a metal that can substitute for Li in the structure and x>0.05 and can be selected from but not limited to Al3+, Ga3+, Be2+, Fe3+, Br3+, B3+, Zn2+, or combinations thereof.

As a further embodiment to the disclosed invention, the ionically conductive ceramic material selected for the three-dimensional ionically and/or electronically conductive solid-state or hybrid electrolyte scaffold come from the class of doped lithium garnets with the chemical formula Li7-xBxLa3Zr2-xO12. In this embodiment, B is a metal that can substitute for Zr in the cubic structure and x>0.05 and can be selected from but not limited to Ta5+, Nb5+, In3+, Sn4+, Ge4+, Si4+, Ca2+, Ba2+, Hf4+, Mg2+, Sc3+, Ti4+, V5+, Cr3+, Mn4+, Co4+, Ni2+, Cu2+, Ge4+, As5+, Se4+, Nb5+, Mo4+, Tc4+, Ru4+, Rh3+, Pd4+, Cd2+, In3+, Sn4+, Sb5+, Te4+, I5+, W4+, Ir4+, Pt4+, Au3+, Hg2+, T13+, Pb4+, Ce4+, Pr3+, Nd3+, Ac3+, Th4+, or combinations thereof.

As a further embodiment to the disclosed invention, the ionically conductive ceramic material selected for the three-dimensional ionically and/or electronically conductive solid-state or hybrid electrolyte scaffold come from the class of doped lithium garnets with the chemical formula Li7-xBxLa3Zr2-xO12. In this embodiment, B is a metal that can substitute for Zr in the cubic structure and x>0.05 and can be selected from but not limited to Na+, K+, Rb+, Cs+, Ca2+, Sr2+, Ba2+, Y3+, Ag+, Bi3+, Ac3+, Bi3+, or combinations thereof.

### Dense Layer Morphology and Properties

It should be understood by someone well-versed in lithium-ion battery subject matter that transition metals are generally not suitable for electrolytes because they can be reduced against a lithium anode. Despite that fact, 3d transition metals are particularly interesting because of their low molar mass. As such, a physical barrier that is nonconductive to electrons but highly conductive to Li+ can be inserted between the anode active material and the transition metal-doped LLZO. For example, Al3+ can be reduced at the lithium anode and therefore is governed by the same concerns. As a further embodiment to the disclosed invention, the three dimensional ionically and/or electronically conductive solid-state or hybrid scaffold that is comprised of metal-doped LLZO is separated from the anode active material using undoped LLZO, or LLZO doped with dopants having a greater affinity for the LLZO lattice than their base metal form. Additionally, this separation can be created in-situ during operation of the battery.

As a further embodiment of the disclosed invention, the undoped and/or cation-doped LLZO selected to form the three dimensional ionically and/or electronically conductive solid-state or hybrid scaffold can be isolated from the anode active material by using a porous polymer separator impregnated with a liquid containing Li+ and with an appropriately large ionic conductivity that is stable both at the undoped and/or cation-doped LLZO and the anode electrochemically active material. An exemplary form of this embodiment is the usage of polyethylene with 45% porosity and thickness of 16 μm in conjunction with electrolytes containing carbonate solvents.

As a further embodiment of the disclosed invention, the cation-doped LLZO selected to form the three dimensional ionically and/or electronically conductive solid-state or hybrid scaffold can be isolated from the anode active material by using a porous glass that is nonconductive to electrons and may or may not be conductive to ions that is wetted by an electrolyte solution containing lithium ions. An exemplary form of this embodiment is the usage of borosilicate glass fiber mats.

As a further embodiment of the disclosed invention, the cation-doped LLZO selected to form the three dimensional ionically and/or electronically conductive solid-state or hybrid scaffold can be isolated from the anode active material by using a fully dense ceramic solid electrolyte that is nonconductive to electrons and highly conductive to ions. In this particular embodiment, electronic conductivity less than 1E-4 S/cm and ionic conductivity >1E-4 S/cm has been achieved and is desired.

As a further embodiment of the disclosed invention, the cation-doped LLZO selected to form the three dimensional ionically and/or electronically conductive solid-state or hybrid scaffold can be isolated from the anode active material by using a fully dense glass solid electrolyte that is nonconductive to electrons and highly conductive to ions. Glass electrolytes from the sulfide family, particularly Li2S—P2S5, Li7P3S11, LiPON, Li3PO4, Li3N, Li10GeP2S12, Li1.3Al0.3Ti1.7(PO4)3, Li1.5Al0.5Ge1.5(PO4)3 and combinations thereof.

It is generally understood that in powder processing, and particularly ceramic processing, reducing the particle size of the powder would result in lowering the sintering temperature because it increases the difference in surface free energy of the powder and sintered part aiding in suppressing lithium loss and reducing manufacturing costs. As an additional embodiment of this disclosure, using ceramic particles that have diameters of less than 1 μm is desired, with the exemplary form of this embodiment being the usage of Al-doped LLZO particles with an average diameter in the range of 100 μm to 500 μm.

As a further embodiment to the disclosed invention, the ionically conductive ceramic material selected for the three-dimensional ionically and/or electronically conductive solid-state or hybrid scaffold comes from the family of solid electrolyte polymers including but not limited to poly(ethylene oxide), poly(propylene oxide), poly(butylene oxide) or their mixtures, polyimide, polyamide, poly(vinyl pyridine), Li-exchanged Nafion or similar cation exchange polymers, polyacrylonitrile, polyvinylpyrrolidone, poly(methyl methacrylate), poly(vinylidene fluoride), poly(vinylidene fluoride-co-hexafluoropropylene) and combinations thereof.

In certain embodiments of the three-dimensional ionically and/or electronically conductive solid-state or hybrid scaffold aspect of this disclosure it may be beneficial to combine the polymers, ceramics, and/or glasses into a hybrid configuration to increase the ionic conductivity, improve the electrochemical stability, enhance the mechanical properties or some combination of all of those improvements.

In one embodiment of the three-dimensional ionically and/or electronically conductive solid-state or hybrid scaffold aspect of this disclosure a liquid is added in addition to any ceramics, polymers, or glasses to improve the ionic conductivity, reduce the interfacial impedance, enhance the electrochemical stability or some combination of all of these properties.

Further disclosed are desired morphologies and materials required of the electronically insulating and ionically conducting separator that has shear modulus greater than 8.5 MPa and bulk density greater than 95%, sufficient to retard the growth of dendrites from the anode to the cathode to enable complete utilization of the electrochemically-active materials at discharge rates in excess of full discharge over 3 hours and more typically a full discharge in 0.25 hours.

### Liquid Electrolyte

Per one feature of the disclosure the hybrid solid state battery comprises a secondary electrolyte phase that enable a conducting interface with the anode and the cathode active materials. The secondary electrolyte phase is a conducting interface made of a liquid electrolyte that can improve the lithium ion charge transfer kinetics and interfacial behavior of the ceramic electrolyte c-LLZO described in this application.

Per another feature of the disclosure the liquid secondary electrolyte phase comprises one or multiple solvents, in which one of more conducting lithium salts can be dissolved in appreciable molarities.

Further disclosed are several avenues to enhance the interfacial behavior of an all solid-state and hybrid lithium-ion battery based on garnet type ceramic electrolytes. The present disclosure aims at maximizing current distributions at both interfaces namely the cathode and the anode interface by increasing electrode active material/electrolyte interfacial areas to enhance tolerable current densities with a target performance greater than 2.5 mA/cm² and C/3 charge/discharge rates at ambient temperature.

In one embodiment the electrolyte introduced into the composite cathode pores to improve the charge transfer between the electrodes and lower any interfacial resistance is a liquid at slightly elevated temperature, which for the sake of this disclosure is of the range 40° C. to 100° C., with the embodiment being in the range of 60° C. to 80° C.

In another embodiment a liquid electrolyte is introduced between the anode material and the ceramic electrolyte to lower interfacial impedance and achieve high discharging/charging rates for the hybrid lithium-ion battery.

In one embodiment the liquid electrolyte comprises one or more solvents selected from the group consisting of but not limited to carbonates, esters, ethers, sulfones, ketones, amides, nitriles, imides and combinations thereof.

In another embodiment there is provided herein a hybrid lithium ion battery comprising a liquid electrolyte composition at the interface between the cathode and/or the anode and the ceramic electrolyte, wherein the nonaqueous electrolyte composition comprises at least one electrolyte salt and at least one fluorinated acyclic carboxylic acid ester and/or at least one fluorinated acyclic carbonate.

In another embodiment the liquid electrolyte contains at least one electrolyte salt. Suitable electrolyte salts include without limitation lithium hexafluorophosphate, lithium bis(trifluoromethanesulfonyl)imide, lithium bis(perfluoroethanesulfonyl)imide, lithium (fluorosulfonyl) (nonafluorobutanesulfonyl)imide, lithium bis(fluorosulfonyl)imide, lithium tetrafluoroborate, lithium perchlorate, lithium hexafluoroarsenate, lithium trifluoromethanesulfonate, lithium tris(trifluoromethanesulfonyl)methide, lithium bis(oxalato)borate, lithium difluoro(oxalato)borate and combinations thereof.

According to yet another feature the electrolyte lithium salt can be contained in the liquid secondary electrolyte phase in an amount of about 0.1 to about 4 mol/L, and more preferably of about 1 to about 3 mol/L.

In an embodiment the liquid electrolyte is made of a room temperature ionic liquid comprising an organic cation and an organic anion. For example, the organic cation is a hydrocarbon comprising at least one charged atom selected from the group of N+, P+, C+, S+ and combinations thereof. For example, the organic anion is selected from a halide ion, a polyhalide ion, a complex anion containing at least one halide ion CF3SO3, CF3COO, (CF3SO2)3C, NO3, PF6, BF4, N(CN)2, C(CN)3, NCS, RSO3, and combination thereof.

### Bilayer Post-Processing

As an additional embodiment of the present disclosure, the thickness and planarity of the three-dimensional electronically and/or ionically conductive solid-state or hybrid electrolyte scaffold and/or the electronically insulating and ionically conducting solid-electrolyte separator can be controlled by using mechanical techniques including but not limited to sanding, polishing, lapping, chemical etching, plasma etching, laser ablation, photoablation, milling and combinations thereof.

As an additional embodiment of the present disclosure, the porosity of the three-dimensional electronically and/or ionically conductive solid-state or hybrid electrolyte scaffold can additionally be controlled by using mechanical techniques including but not limited to chemical etching, plasma etching, laser ablation, photoablation, milling and combinations thereof.

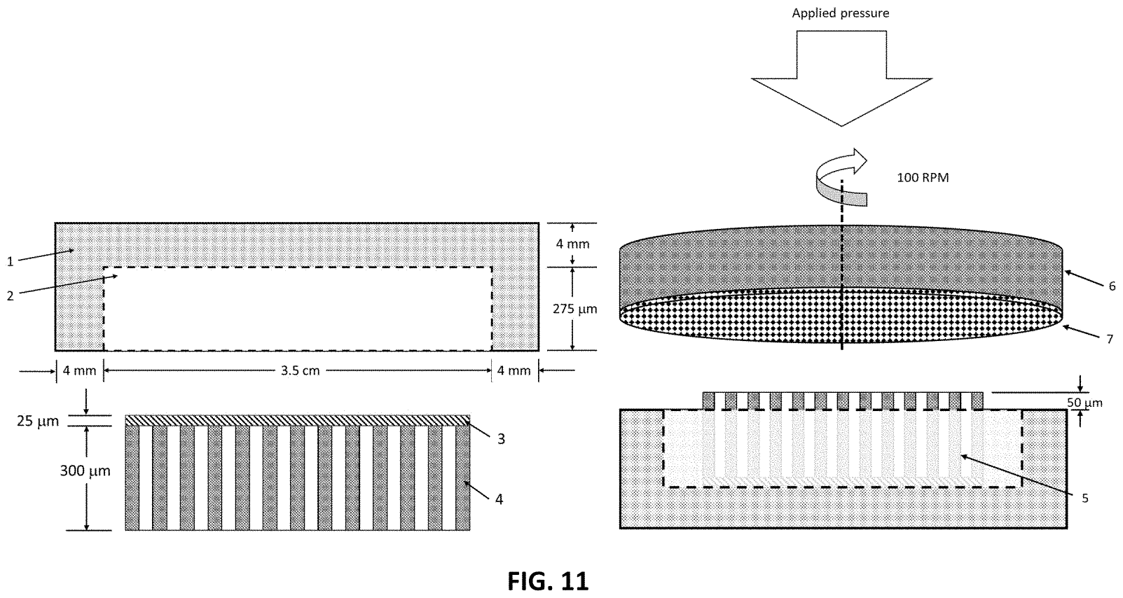

As an additional embodiment of the present disclosure, the geometry of the three-dimensional electronically and/or ionically conductive solid-state or hybrid electrolyte scaffold can additionally be controlled by using mechanical techniques including but not limited to sanding, polishing, lapping, chemical etching, plasma etching, laser ablation, photoablation, milling, milling and combinations thereof. FIG. 11 discloses schematically one particular invention suitable for producing 275 um thickness parts, whereby an electrolyte scaffold is placed into a cavity of fully-dense LLZO that is 275 um in thickness and is polished using diamond lapping paper on a rotating polishing wheel.

### Infiltration

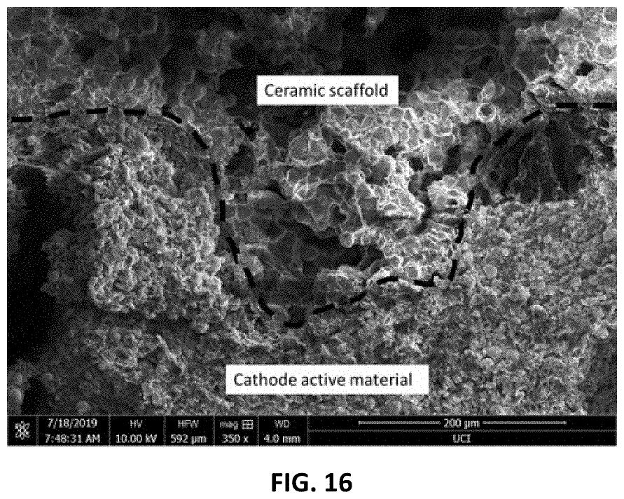

Per one feature of this disclosure, the method described herein further comprises the step of infiltrating the pores of the three-dimensional ionically and/or electronically conductive solid-state or hybrid electrolyte scaffold with one or more components selected from but not limited to a liquid electrolyte, anode active material, a cathode active material, a solid electrolyte, conductive additive, polymer electrolyte, gel electrolyte, surfactant, inorganic filler, corrosion inhibiter, film former, electrolyte salts, and combinations thereof. FIG. 16 shows a SEM micrograph of a cathode slurry infiltrated into the pores of a c-LLZO scaffold.

In one embodiment of the disclosure, the three-dimensional ionically and/or electronically conductive solid-state or hybrid scaffold can be infiltrated with electrochemically active cathode or anode materials by producing a slurry of the electrochemically-active materials, depositing said slurry onto the porous surface of the of the three-dimensional ionically and/or electronically conductive solid-state or hybrid scaffold and allowing capillary action and gravity to insert the electrochemically-active material into the porous structure. Loadings in terms of mass of electrochemically active material per unit surface area can be controlled by modulating the solids loading of the electrochemically-active material slurry, or the amount of electrochemically-active material slurry deposited.

Per another embodiment of this disclosure, the tool used to deposit the electrochemically-active material slurry has resolution of <10 μm and in the x-y direction.

Per an additional embodiment of this disclosure, the tool used to deposit the electrochemically-active material slurry can deposit quantities of electrochemically-active material slurry as low as 10 μL and as high as 1,000 μL.

Per an additional embodiment of this disclosure, the electrochemically-active material slurry is deposited in one location on top of the three-dimensional ionically and/or electronically conductive solid state or hybrid electrolyte scaffold and bedaubed across the entire surface.

Per an additional embodiment of this disclosure, the electrochemically-active material slurry is deposited over the entirety of the part.

Per an additional embodiment of this disclosure, excess electrochemically-active slurry is removed from the surface of the electrochemically-active material slurry using techniques including but not limited to: wiping with an absorbent cloth, using a rubberized squeegee, using a jet of gas, and combinations thereof.

Per an additional embodiment of this disclosure, excess electrochemically-active slurry is allowed to remain on top of the surface of the three-dimensional ionically and/or electronically conductive solid-state or hybrid electrolyte scaffold. In this embodiment, the electrochemically-active slurry can either have the solvent removed and current collectors can be attached following a drying step, or the slurry can be allowed to have some amount of solvent remaining, up to 100% of the original solvent loading to aid in current collector attachment. In this embodiment, the overlayer of electrochemically-active slurry can have thickness when dried of 0 μm to 300 μm.

In this embodiment of the present disclosure, insertion of the electrochemically-active slurry into the pores of the three-dimensional ionically and/or electronically conductive solid-state or hybrid scaffold can be further assisted by applying the slurry over the entire surface of the three-dimensional ionically and/or electronically conductive solid-state or hybrid electrolyte scaffold using the methods described herein under a pressure lower than atmospheric pressure, but above the solvent boiling point, followed by a gas pressurization step.

Per an additional embodiment of the present disclosure, insertion of the electrochemically-active slurry into the pores of the three-dimensional ionically and/or electronically conductive solid-state or hybrid scaffold can be further assisted by applying vibration following the application of slurry over the entire surface of the three-dimensional ionically and/or electronically conductive solid-state or hybrid electrolyte scaffold.

Per an additional embodiment of the present disclosure, insertion of the electrochemically-active slurry into the pores of the three-dimensional ionically and/or electronically conductive solid-state or hybrid scaffold can be further assisted by applying a magnetic field following the application of slurry over the entire surface of the three-dimensional ionically and/or electronically conductive solid-state or hybrid electrolyte scaffold.

Per an additional embodiment of this disclosure, the electrochemically-active slurry does not contain a liquid and is infiltrated into the pores of the three-dimensional solid-state or hybrid electrolyte scaffold in its dry state. In this embodiment, the dry mixture of solids and components thereof contains but is not limited to anode active material, a cathode active material, a solid electrolyte, conductive additive, polymer electrolyte, gel electrolyte, surfactant, inorganic filler, corrosion inhibiter, film former, electrolyte salts.

Per an additional embodiment of the present disclosure concerning, insertion of the dry mixture of electrochemically-active and inactive materials into the pores of the three-dimensional ionically and/or electronically conductive solid-state or hybrid scaffold can be further assisted by applying vibration following the application of slurry over the entire surface of the three-dimensional ionically and/or electronically conductive solid-state or hybrid electrolyte scaffold.

Per an additional embodiment of the present disclosure concerning insertion of the dry mixture of electrochemically-active and inactive materials into the pores of the three-dimensional ionically and/or electronically conductive solid-state or hybrid scaffold can be further assisted by applying a strong magnetic field following the application of slurry over the entire surface of the three-dimensional ionically and/or electronically conductive solid-state or hybrid electrolyte scaffold.

Per an additional embodiment of the present disclosure concerning insertion of the dry mixture of electrochemically-active and inactive materials into the pores of the three-dimensional ionically and/or electronically conductive solid-state or hybrid scaffold, multiple coating steps of one, many or all of the above methods may be utilized.

According to an additional feature, concerning insertion of the mixture of electrochemically-active and inactive materials into the pores of the three-dimensional ionically and/or electronically conductive solid-state or hybrid scaffold one or more of bar coating, wire wound rod coating, drop casting, freeze tape casting, freeze casting, casting, spin casting doctor blading, dip coating, spray coating, microgravure, screen printing, ink jet printing, 3D printing, slot die casting, reverse comma casting, acoustive sonocasting, acoustic field patterning, magnetic field patterning, electric field patterning, photolithography, etching, and self-assembly may be used.

According to an additional feature of the disclosure disclosed herein, following the insertion of electrochemically-active and inactive materials into the pores of the three-dimensional ionically and/or electronically conductive solid-state or hybrid scaffold, a conductive polymer may be additionally inserted into the electrochemically-active material interstitial porosity by adding a polymer monomer using one many, or all of the methods detailed herein and polymerizing using cationic polymerization, anionic polymerization, free-radical polymerization, condensation polymerization, emulsion polymerization, solution polymerization, suspension polymerization, precipitation polymerization, photopolymerization, plasma polymerization, and/or electrochemical polymerization. Someone skilled in the art would recognize that the polymers including but not limited to polyaniline, polypyrrole, polyacetylene, polythiophene, poly(3,4-ethylenedioxythiophene), poly(p-phenyl sulfide), poly(p-phenylene vinylene) can be used according to the methods disclosed herein.

According to an additional feature of the invention disclosed herein, following the insertion of electrochemically-active and inactive materials into the pores of the three-dimensional ionically and/or electronically conductive solid-state or hybrid scaffold, a conductive carbon may be additionally inserted into the electrochemically-active material interstitial porosity by utilizing general methods of carbon deposition which can be generally grouped into catalytic hydrocarbon gas decomposition, organic compound decomposition and thermal oxidation of polyacrylonitrile. FIG. 14 shows schematically what such a hybrid structure would look like. A thin, single-digit nanometer coating of carbon is left on the surface of the porous scaffold. Numerous routes can be utilized to produce the desired conductive carbon that would be obvious to someone skilled in the art and the exemplary embodiments are disclosed herein. In the first general embodiment, a dilute solution of sucrose, an organic compound, typically in the range of 1 wt. % to 20 wt. % and more typically 5 wt. %, is produced in an appropriate solvent, then is introduced into the pores of the three-dimensional solid-state or hybrid scaffold. This can be accomplished by any number of techniques, with the simplest being the use of a pipette or similar. The solution is then evaporated by heating at a temperature in the range of 50° C. to 100° C. to produce a coating of the organic compound, in this case sucrose, on the surface of the pore walls of the three-dimensional solid-state or hybrid scaffold. The coated three-dimensional solid-state or hybrid scaffold is then placed into an oven containing an inert atmosphere and heated to a temperature of 400° C. to 900° C. which causes decomposition of the organic compound into an amorphous carbon that provides electronic conductivity while still enabling access of lithium ions to the ionically-conducting three-dimensional solid-state or hybrid scaffold.

In the second general embodiment, a hydrocarbon gas is introduced into an environment that contains the three-dimensional solid-state or hybrid scaffold at a temperature above the temperature where the hydrocarbon gas is thermodynamically stable. In general, these temperatures are greater than 400° C. Someone skilled in the art would recognize that numerous materials disclosed herein that comprise the three-dimensional solid-state or hybrid scaffold would be catalytic to growing low dimensionality (zero-dimensional, one-dimensional and/or two-dimensional) carbon nanostructures at a temperature in the range of 500° C. to 1100° C.

An additional and exemplary embodiment of this disclosure is the purposeful inclusion of carbonization catalysts that both encourage the growth of highly conductive and low dimensionality carbon nanostructures and become incorporated into the crystal lattice on the lithium site of LLZO, which reduces the effects of high temperature lithium loss and encourages the stabilization of the cubic phase of LLZO. One choice would be iron. Additionally, as an exemplary example of the present disclosure 2.5% acetylene in 97.5% argon when used as the precursor gas with iron oxide nanoparticles with diameter in the range of 1 nm to 100 nm, such as 5 nm at a temperature of 600° C. results in a structure with facile electron and ion transport. In the third embodiment carbon-forming polymers such as polyacrylonitrile (PAN) or poly(1,3-diethnylbenzene) (PAB), which someone skilled in the art would recognize as being the predominant carbon fiber precursor, is introduced into the pores of the tree-dimensional solid-state or hybrid scaffold through either solution deposition, as was previously disclosed for the embodiment concerning organic material decomposition, or through direct polymerization of acrylonitrile monomers using a radical initiator. The polyacrylonitrile is then slowly heated to 400° C. to carbonize the polyacrylonitrile. As an additional embodiment, the polyacrylonitrile can be further graphitized to increase the electronic conductivity by heating to temperatures of approximately 1000° C. As described previously for hydrocarbon gas decomposition, iron can be advantageously added to reduce the temperature at which carbon graphitizes or becomes low dimensional structures in the form of iron oxide nanoparticles, or, in the case of polyacrylonitrile, a metal organic compound containing iron such as ferrocene.

### Current Collector Attachment

The development of a novel battery architecture necessitates the development of novel ancillary systems in the battery as well. Crucial among these are the current collectors, which for the sake of this disclosure are metallically-conducting and electrochemically inert materials that pass charge from the circuitry outside of the battery cell to the electrochemically-active components inside of the cell and visa versa. Traditionally, aluminum foil of alloy Al1100 or Al3003 having thickness of 5 μm to 50 μm and with a conductive carbon coating of typically 0.1 μm to 10 μm consisting of carbon black in an acrylate polymer are used for the cathode current collector. Commercially-pure copper foil of thickness of 5 μm to 50 μm that is typically uncoated is used as the anode current collector in traditionally-processed lithium-ion batteries. In the present disclosure, because of the unique architecture of the three-dimensional ionically and/or electronically conductive solid-state or hybrid electrolyte scaffold that is physically and/or chemically attached to a fully-dense electronically insulating and ionically conducting separator with the pores of the three-dimensional scaffold being largely isolated from one another, liquid electrolyte, meant to reduce charge transfer impedances by improving contact areas also remains largely isolated inside of individual pores in the scaffold. As such, traditional methods of inserting a cell stack into a can or pouch and vacuum infiltrating electrolyte whereby the electrolyte can penetrate through to the electrodes along the path of the porous separator material and sealing the pouch or can do not work.

In one embodiment, the present disclosure teaches using aluminum, either carbon coated or not, woven mesh, perforated sheet, expanded sheets, foams, honeycombs, wool or similar non-solid material to improve electrolyte wetting of the cathode. Additionally, the present invention discloses using uncoated copper woven mesh, perforated sheet, expanded sheets, foams, honeycombs, wool or similar non-solid material to improve electrolyte wetting of the anode. Additionally, when lithium metal is used as the anode electrochemically-active material, using a higher dimensionality copper current collector provides physical space to accommodate the shrinkage and growing of the lithium without requiring excessive cell pressures on the stack. In the present disclosure, there is a change in lithium thickness in each cell pair of electrodes by 10 μm to 50 μm during each full charge/discharge cycle that needs to be accommodated.

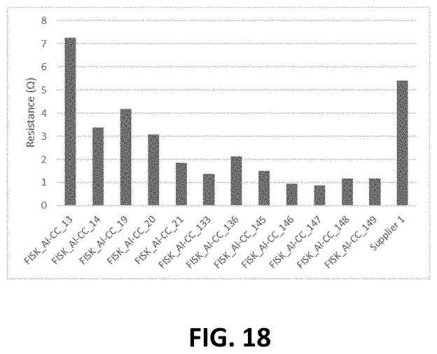

The previously disclosed embodiment addresses electrolyte wetting in single-layer pouch cells and the composite electrodes at the top and bottom of a prismatic stack but is not effective for ensuring good electrolyte wetting for multi-layer prismatic cell stacks. The present invention addresses this by disclosing the methods and materials to produce current collectors that can be attached to the hybrid solid-state battery architecture following the addition of any liquid to the infiltrated three-dimensional composite solid-state or hybrid solid state electrodes. This is shown schematically in FIG. 18 and is accomplished by providing current collectors with conductive adhesive, either pressure sensitive adhesive or hot melt adhesive, filled with an appropriate amount of carbon. FIG. 18 shows through-plate electrical resistance of 12 such thermoplastic current collectors. Carbons of the form carbon black, nanocrystalline graphite, graphene, multi-layer graphene, single-wall carbon nanotubes, double-wall carbon nanotubes, multi-wall carbon nanotubes, carbon fullerenes, carbon nanodiamond, microcrystalline graphite, nanocrystalline graphite, amorphous carbon, amorphous porous carbon, activated carbon, Ketjen black, and combinations thereof all work in the application.

For the sake of this disclosure, a hot melt adhesive is formed by combining a blend of polymers from the families of polyethylene, ethylene-vinyl acetate ethylene-co-ethyl acetate, and combinations thereof in a ratio to produce a substantial softening at 80° C. to 150° C. The addition of carbon lowers the softening temperature, but also reduces the tackiness. In the present invention it is disclosed that a mass fraction of carbon in the range of 1 wt % to 20 wt % is most desirable and that carbons with more conjugation produce substantially higher conductivities. At low discharge rates, current collectors manufactured using this protocol produce through plane conductivities of >1E1 S/m. In an additional embodiment to this disclosure, pressure sensitive adhesives can be produced using a very similar procedure. In general, the pressure sensitive adhesive is produced from a mixture of acrylics and short chain styrene butadiene rubbers with carbon being added in a mass fraction of 1% to 10% and has a thickness less than 10 μm.

Additionally there is disclosed the addition of polymeric materials to the current collector to enhance the conductivity. These materials fall into the broad families of but not limited to polyanilines, polypyrroles, polyacetylenes, polylthiophenes, poly(3,4-ethylenethiophosphene), poly(p-phenylene sulfide), poly(p-phenylene vinylene). When these materials are added in a range of 1 wt. % to 50 wt. % conductivity is enhanced. It is of particular interest to combine polypyrroles and carbon nanotubes for both tack and conductivity.

Depending on the application, liquid electrolytes with different thermal stabilities may be desired. For solvents with low boiling points, such as the ethers, or formulations with numerous unstable or marginally stable additives such as vinylene carbonate, using current collectors coated with a pressure sensitive conductive adhesive is the preferred embodiment. For high boiling point or nonvolatile liquids such as the solvent N-butyl-N-methyl bis(fluorosulfonyl)imide, or carbonate-based solvents with larger linear carbonate molecules, the hot melt adhesive is the preferred embodiment. In both embodiments, it is preferable to introduce the liquid into the composite electrode structure prior to attaching the current collectors.

Per a further feature the producing the three-dimensional porous scaffold with ionic and/or electronic conductivity filled with electrochemically-active material comprises casting a plurality of the solid-state electrolyte and/or hybrid electrolyte slurry, the electrochemically-active material slurry, and the separator with sufficient mechanical properties to retard dendrite growth and combinations thereof directly onto a current collector.

Although an exemplary embodiment of the present disclosure has been described and illustrated, it will be apparent to those skilled in the art that numerous modifications and variations can be made thereto without departing from the scope of the invention as defined in the appended claims.

### Example 1

In one embodiment, an anode or negative electrode consists in 100 microns thick lithium metal coated onto a 10 microns thick copper foil current collector (MTI Corporation). A 16 microns thick microporous separator (SK innovation) comprising 75 μl/cm² of a Li+ conducting non-aqueous electrolyte was used as interface between the lithium anode and the solid electrolyte containing c-LLZO. The liquid electrolyte consisted in a mixture of lithium bis(fluorosulfonyl)imide (LiFSI, 99+%, Fluolyte) 1.2M dissolved in ethylene carbonate (EC):ethyl methyl carbonate (EMC) (3/7 v/v) (SoulBrain Mich.) with 5 wt. % lithium hexafluorophosphate (LiPF6, Sigma-Aldrich), 5 wt. % fluoroethylene carbonate (FEC, Sigma-Aldrich), and 5 wt. % lithium difluoro(oxalato)borate (LiDFOB, Sigma-Aldrich). The liquid electrolyte formulation comprised additives improving cycle life of lithium metal anodes. The liquid electrolyte water content was measured by Karl Fischer titration and found to be ca. 40 ppm.

### Example 2

A polymer mixture comprising polyvinylidene difluoride (PVdF, Solvay) was prepared by mixing 0.25 grams of the polymer in 2.25 grams of N-methylpyrrolidinone (NMP, 99%, anhydrous, Sigma-Aldrich). The mixture was stirred for about 12 hours in a milling jar. A cathode mixture comprising 0.25 grams of conducting carbon black (SGP-5, Imerys), 0.25 grams of another conducting carbon black (Super-C, Timcal), and 4.25 grams of cathode active material LiNi0.6Mn0.2Co0.2O2 (NMC622, Umicore) was then added to the polymer mixture. The mixture was then be vigorously mixed in the high shear mixer until a substantially homogeneous blend was obtained. The cathode slurry containing the active material was then infiltrated within the porous c-LLZO scaffold using a vacuum apparatus inside an Ar-filled glovebox. The porous c-LLZO scaffold had a thickness of about 100-500 μm. In various examples, the thickness was 300-400 μm, such as 350 μm. The 16 microns thick carbon-coated aluminum current collector (MTI Corporation) was attached onto the cathode containing the electro-active material and c-LLZO porous scaffold. The cathode/current collector was vacuum dried at 120° C. for 24 hours to remove the NMP. Preferably, the cathode has an active material areal loading of about 20 to about 60 mg/cm2 and more preferably at about 50 mg/cm2.

### Example 3

To polymer solution comprising 0.25 g polyvinylidene difluoride in 2.25 g n-methyl-2-pyrrolidone, 4.5 g of LiNi0.6Mn0.2Co0.2O2 available from Umicore (Brussels, Belgium), 0.25 g SGP-5 synthetic graphite from (SEC Carbon, Hyogo Japan) and 0.25 g Super C65 from Imerys Graphite & Carbon (Paris, France) was added into a borosilicate mixing vessel. The mixture was gently mixed using an overhead mixer while 9.4 g additional n-methyl-2-pyrrolidone was added for 10 minutes. A suitable mixer was from IKA, Model Eurostar 20. The slurry was then vigorously mixed using a high shear mixer for 30 minutes at about 10,000 RPM. A suitable mixer was from Lanyo model AD500S-H.

The cathode slurry was then deposited on top of a square bulk composite electrode of width 3 cm and length 3 cm having a co-sintered bilayer of 95% bulk density Li6.75Al0.25La7Zr3O12 with 25 μm thickness and Li6.75Al0.25La7Zr3O12 of approximately 20% bulk density and 350 μm thickness by pipetting 400 UI of the cathode slurry evenly across the surface using a micropipette. A suitable one was an Eppendorf Research 2100 series single channel pipette.

Following the application of the cathode slurry, a cathode current collector can be employed which was a sheet of expanded aluminum metal with a thickness of 25 μm and an open area of 50%. It was available from Dexmet Corporation (Wallingford, Conn., USA). A 3 cm by 3 cm square with a 0.4 cm by 0.4 cm square tab can be cut using scissors forming the cathode current collector for the current example. The composite electrode can be allowed to sit for a period of 15 minutes subsequent to slurry deposition at a temperature between 20° C. and 50° C. Following this, the cut current collector can be positioned on top of the 3 cm by 3 cm bulk composite cathode and the NMP allowed to evaporate. An additional drying step of 12 h at 120° C. at a pressure of −10 kPa can be employed.

### Example 4

Alternatively, a cathode current collector can be employed which was a solid sheet of aluminum of 16 μm thickness with a 1 μm coating of acrylate adhesive containing a conductive carbon available from MTI Corporation (Richmond, Calif., USA). To a polymer solution comprising 0.25 g polyvinylidene difluoride in 2.25 g n-methyl-2-pyrrolidone, 4.5 g of LiNi0.6Mn0.2Co0.2O2 available from Umicore (Brussels, Belgium), 0.25 g SGP-5 synthetic graphite from (SEC Carbon, Hyogo Japan) and 0.25 g Super C65 from Imerys Graphite & Carbon (Paris, France) was added into a borosilicate mixing vessel. The mixture was gently mixed using an overhead mixer while 9.4 g additional n-methyl-2-pyrrolidone was added for 10 minutes. A suitable mixer was from IKA, Model Eurostar 20. The slurry was then vigorously mixed using a high shear mixer for 30 minutes at about 10,000 RPM. A suitable mixer was from Lanyo model AD500S-H.

The cathode slurry was deposited on top of a square bulk composite electrode of width 3 cm and length 3 cm having a co-sintered bilayer of 95% bulk density Li6.75Al0.25La7Zr3O12 with 25 μm thickness and Li6.75Al0.25La7Zr3O12 of approximately 20% bulk density and 350 μm thickness by pipetting 400 uL of the cathode slurry evenly across the surface using a micropipette. A suitable one was an Eppendorf Research 2100 series single channel pipette.

A 3 cm by 3 cm square with a 0.4 cm by 0.4 cm square tab was cut using scissors forming the cathode current collector for the current example. The composite electrode was allowed to sit for a period of 15 minutes subsequent to slurry deposition at a temperature between 20° C. and 50° C. Following this, the cut current collector was positioned on top of the 3 cm by 3 cm bulk composite cathode and the NMP allowed to evaporate. An additional drying step of 12 h at 120° C. at a pressure of −10 kPa was employed.

### Example 5

Alternatively, a cathode slurry was made using poly(4-vinylpyridine), available from Sigma Aldrich. To a polymer solution comprising 0.25 g poly(4-vinylpyridine) in 2.25 g dimethylformamide, 4.5 g of LiNi0.6Mn0.2Co0.2O2 available from Umicore (Brussels, Belgium), 0.25 g SGP-5 synthetic graphite from (SEC Carbon, Hyogo Japan), and 0.25 g Super C65 from Imerys Graphite & Carbon (Paris, France) was added into a borosilicate mixing vessel. The mixture was gently mixed using an overhead mixer while and additional 9.4 g dimethylformamide was added for 10 minutes. A suitable mixer was from IKA, Model Eurostar 20. The slurry was then vigorously mixed using a high shear mixer for 30 minutes at about 10,000 RPM. A suitable mixer was from Lanyo model AD500S-H.

### Example 6

Alternatively, a carbon coating was done to the bulk composite electrode scaffold prior to filling with electroactive material. To a stirring 20 mL solution of methanol heated to 60° C., 1 g of sucrose was added. The sucrose/ethanol solution was stirred for a further 15 minutes before 0.2 mL deionized water was added dropwise, waiting 90 seconds between successive additions, until the solution was no longer turbid.

The sucrose/methanol solution was deposited on top of a rectangular bulk composite electrode of width 2 cm and length 3 cm having a co-sintered bilayer of 95% bulk density Li6.75Al0.25La7Zr3O12 with 25 μm thickness and Li6.75Al0.25La7Zr3O12 of approximately 20% bulk density and 350 μm thickness by pipetting 250 uL of the cathode slurry evenly across the surface using a micropipette. A suitable one is an Eppendorf Research 2100 series single channel pipette.

Subsequent to the sucrose/ethanol addition, the rectangular bulk composite electrode was dried in a drying oven at 50° C. for 2 h. A suitable one was an American Scientific Products DX-58.

The dried sucrose-coated rectangular bulk composite electrode of width 2 cm and length 3 cm was placed into a furnace and heated at a heating rate of 5° C./min to 600° C. under an argon atmosphere and subsequently cooled back to room temperature at a natural rate. FIG. 15A shows a SEM micrograph of the composite c-LLZO scaffold with carbon deposited on the surface. FIG. 15B shows an elemental mapping of carbon using energy dispersive X-ray spectroscopy on the c-LLZO bilayer showing successful carbon deposition. Note the color is grey, compared to the brilliant white of the as-sintered c-LLZO scaffold. FIG. 15C is a photograph of the as-prepared c-LLZO solid state electrolyte coated with carbon within the pores.

### Example 7

A bulk composite electrode scaffold having a 300 μm thickness layer with porosity >50% and a 25 μm thickness layer with porosity <5% that are physically attached through co-sintering was further improved by mechanical planarization. To remove the top-most 50 μm from the highly porous scaffold, a planarization jig which consists of a 275 μm thickness deep cavity where the bulk composite electrode scaffold was housed (FIG. 11) was employed along with a lapping film. A suitable one for the latter was Diamond Lapping Film 661X from 3M.

The bulk composite electrode scaffold was placed into the planarization jig (1) with the dense layer (3) in contact with the bottom of the cavity (2) and the porous layer (4) protruding slightly above the lip of the jig (1). A piece of 3 μm lapping film (7) was placed onto a planarization wheel (6) and the planarization wheel was spun at 120 RPM. The polishing wheel was lowered onto the 6 cm² sample and a force of 100 mN was applied. The planarization can continue until the planarization wheel comes in contact with the planarization jig.

### Example 8

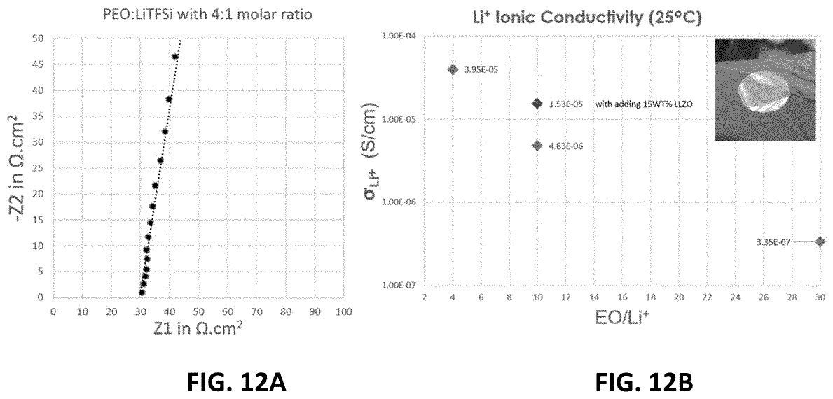

A free-standing polymer separator was prepared first by hand mixing 0.88 g of polyethylene oxide (PEO, MW=600,000, Sigma-Aldrich) and 1.43 g of lithium bis(trifluoromethanesulfonyl)imide (LiTFSI, 99.5%, Acros) using a mortar and a pestle. The materials are previously vacuum dried at 50° C. for 3 days inside an Ar-filled glovebox. PEO and LiTFSI are then added to 7.86 g of anhydrous acetonitrile (ACN, Sigma-Aldrich) and stirred for 24 hours to form a homogenized solution. The solution was tape cast using a doctor blade with 200 microns gap height and vacuum dried for 12 hours into a thin film in an argon filled glove box at 80° C. A series of solid electrolytes are formed using the above process with various amounts of PEO and LiTFSI. A first series of electrolytes are formed having a EO:Li molar ratio of 30:1, 15:1, 10:1, and 4:1. A second series of polymer electrolytes are also formed having a c-LLZO concentration of 5 to 15 wt % incorporated within the PEO:LiTFSI separator. The c-LLZO “additive” was added to the mixture in order to promote Li+ ionic conductivity at room temperature. The electrochemical properties of the polymer electrolytes are measured using an electrochemical instrument (Ivium Technologies). The ionic conductivities of the PEO films are evaluated by the complex plane impedance plots at 25° C. with an impedance analyzer. Each film was sandwiched between two stainless steel (SS) disks (d=1.6 cm) to form a symmetric SS/PEO/SS cell. The free-standing PEO separator has a thickness of ca. 20 microns with room temperature conductivity of ca. 4 10⁻⁵ S/cm (FIG. 12B). The free-standing PEO separator acts as a hybrid interface and/or anolyte between lithium metal anode and c-LLZO solid electrolyte.

### Example 9

A bulk composite electrode was produced by filling a bulk composite scaffold with 300 μm thickness layer with porosity >50% and 25 μm thickness layer with porosity <5% that are physically attached by co-sintering with a cathode slurry consisting of 0.25 g polyvinylidene difluoride in 2.25 g n-methyl-2-pyrrolidone, 4.5 g of LiNi0.6Mn0.2Co0.2O2 available from Umicore (Brussels, Belgium), 0.25 g SGP-5 synthetic graphite from SEC Carbon (Hyogo, Japan), and 0.25 g Super C65 from Imerys Graphite & Carbon (Paris, France). To fill the bulk composite scaffold with the cathode slurry, vibration was utilized. The bulk composite scaffold was placed in a 100 mm diameter petri dish with the 25 μm thickness layer on the bottom. 12.5 mL of cathode slurry was pipetted into the petri dish to cover the 300 μm thickness layer using a disposable plastic pipette. Following this, the petri dish was transferred into a bath ultrasonicator for 15 minutes. A suitable one was the 1.9 L CPXH-Series from Branson Ultrasonics Corp (Danbury, Conn., USA). The bulk composite scaffold filled with cathode slurry was placed on a wire drying rack and excess cathode slurry was removed from the surface of the 300 μm thickness layer using a delicate task wipers. The solvent was partially evaporated by allowing the bulk composite scaffold filled with cathode slurry to sit on the drying rack at room temperature for 24 h. The excess cathode slurry on the 25 μm thickness layer side was removed by flipping the bulk composite scaffold filled with cathode slurry over onto a flat glass plate so the 25 μm thickness layer was facing upwards and wiping away any excess cathode slurry with a solvent-soaked delicate task wiper.

### Example 10

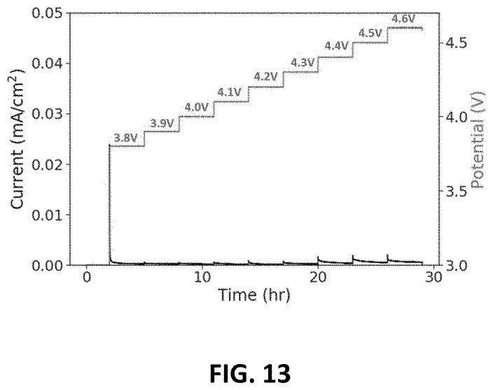

A catholyte containing a liquid electrolyte having high oxidative stability and high chemical compatibility with aluminum-based cathode current collector was used to enhance the performance of a hybrid solid-state battery that comprises a porous c-LLZO 3D scaffold with thickness of 300 μm and porosity >50%. The liquid electrolyte consists in dissolving lithium bis(fluorosulfonyl)imide (LiFSI, 99+%, Fluolyte) in Sulfolane (Alfa Aesar, >98+%) at 2 mol/L inside an Ar-filled glovebox. Sulfolane was dried over molecular sieves until water content was below 50 ppm. LiFSI salt was vacuum dried at 100° C. for 3 days. Electrochemical stability of the as-prepared liquid electrolyte was measured by potential step experiment where the cell potential is increased from 3.8 to 4.6 V by 100 mV increments every 3 hours and using a coin cell (CR2032, MTI Corporation) where the anode or counter electrode consists in Li metal (100 microns thick, MTI Corporation, d=1.2 cm), the separator consists in glass microporous fiber (250 microns thick, Whatman, Grade GF/F, d=1.8 cm) with 75 uL/cm2 of electrolyte, the cathode or working electrode consists in aluminum foil typically used as current collector in hybrid solid-state lithium-ion battery (16 microns thick, MTI Corporation, d=1.4 cm). FIG. 13 shows a chronoamperogram illustrating high electrochemical stability of the liquid electrolyte up to 4.6 V. It also demonstrates chemical stability of the aluminum current collector at high voltage using LiFSI-based liquid electrolyte.

### Example 11

Current collectors can also be produced that utilize a conductive thermoplastic polymer coating. First, to make the slurry, 0.1 g polyethylene (Mw ˜4,000, Sigma Aldrich) was dissolved in 10.0 g toluene by heating and stirring using a magnetic stir plate. 0.005 g carbon black (Super C65, Imerys) was dispersed into the solution by vigorously stirring while slowly adding the carbon. Ultrasonication for 15 minutes after adding the carbon was used to aid in dispersion. Stirring can continue for 1 hour with an intermediate 15-minute sonication step 30 minutes after beginning stirring. Following stirring, the coating slurry was degassed by a final 5 minute ultrasonication.

Following the preparation of the slurry, aluminum cathode current collectors with ˜10 μm thickness and 28 cm width containing a conductive thermoplastic polymer (MTI Corporation, Richmond, Calif. USA) was produced by tape casting with an 8″ doctor blade (Tape Casting Warehouse, Yardney Pa., USA) with height of 200 μm then allowing the solvent to evaporate at room temperature for 3 hours. Following solvent evaporation, an additional heat treatment at 50 QC for 1 hour in air was performed.

### Example 12

Current collectors with a conductive thermoplastic produced from Example 11 was attached to the three-dimensional composite electrodes by the application of slight heat and uniaxial pressure.

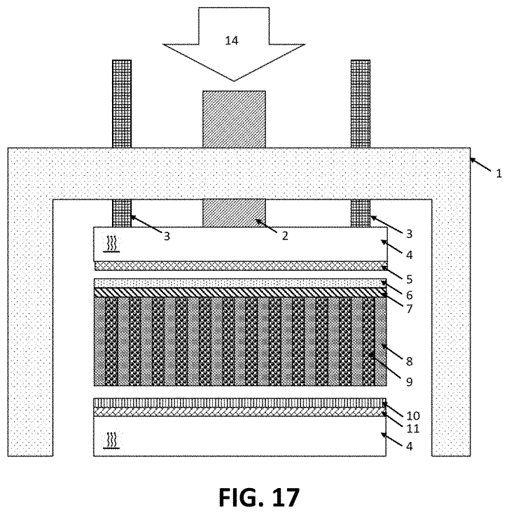

FIG. 17 shows a schematic of a uniaxial press that was used to press current collectors onto three-dimensional composite electrodes such as shown schematically in FIG. 19. A three-dimensional composite electrode (8,9), with attached dendrite-blocking separator (7), and lithium (5) physically bonded was placed on top of an Al current-collector (11) with a conductive thermoplastic coating (10). Additionally, a copper current collector (5) was placed on top of the lithium. 5, 6, 7, 8, 9, 10 and 11 was placed in between the heated plates (4). Pressure (14) was applied. For polyethylene (MW 10,000, Sigma) conductive thermoplastics with 5% carbon black (Super C65, Imerys, Switzerland), and porous scaffolds comprised of Al-doped c-LLZO of 300 μm thickness, dendrite-blocking separator comprised of Al-doped c-LLZO, 90% Li0.6Ni0.2Co0.2O2 active cathode material, 5% PVDF binder, 2.5% SGP-5 (SEC Carbon, Hyogo Japan), 2.5% Super C65 (Imerys, Switzerland), and 100 μm Li on 10 μm Cu foil, 150 Pa and 80 QC for 5 minutes can produce good adhesion of the current collector to the three dimensional composite electrode.

### Example 13

Current collectors with a conductive thermoplastic produced from Example 11 was attached to the three-dimensional composite electrodes, shown schematically in FIG. 19 following the addition of a liquid electrolyte into the pores of the three-dimensional composite electrode by the application isostatic pressure at slightly elevated temperature.

A modified vacuum pouch sealer from MTI Corporation, Richmond Calif., USA, a cell was produced using For polyethylene (MW 10,000, Sigma) conductive thermoplastics with 5% carbon black (Super C65, Imerys, Switzerland), and porous scaffolds comprised of Al-doped c-LLZO of 300 μm thickness, dendrite-blocking separator comprised of Al-doped c-LLZO, 90% Li0.6Ni0.2Co0.2O2 active cathode material, 5% PVDF binder, 2.5% SGP-5 (SEC Carbon, Hyogo, Japan), 2.5% Super C65 (Imerys, Switzerland), and 100 μm Li on 10 μm Cu foil, was used to produce the bond between the current collector and the three-dimensional composite electrode. A 3 cm wide by 3 cm long electrode stack shown schematically in FIG. 19 was produced and have Ni tabs ultrasonically welded to the Cu current collector on the anode side and the Al current collector on the cathode side using a MSK-800W ultrasonic welder from MTI Corporation. The electrode stack was sealed into a standard pouch along with an electrolyte comprising 2 M LiFSI in sulfolane. Following the final vacuum sealing step, the chamber was heated to 80 QC and pressurized to 5 psi for 15 minutes.

### Example 14

In one specific embodiment, the hybrid solid state electrochemical cell comprising the c-LLZO solid electrolyte incorporates a nanofiber separator at the interface between the lithium metal anode and c-LLZO. This separator enables the use of a stable anolyte that reduces the interfacial impedance of the electrochemical cell. The microporous separator has a thickness of 20 microns and was made of aramid nanofibers (DreamWeaver Gold). During cell assembly the separator was filled with the anolyte at 75 μL/cm² loading. The liquid electrolyte was composed of lithium bis(fluorosulfonyl)imide (LiFSI, 99+%, Fluolyte) dissolved at 2 molar concentration in tetramethylene sulfone (Sulfolane, Alfa Aesar, 99+%).

### Example 15

In one specific embodiment, the hybrid solid state electrochemical cell comprising the c-LLZO solid electrolyte incorporates a microporous film at the interface between the lithium metal anode and c-LLZO. This separator enables the use of a stable anolyte that reduces the interfacial impedance of the electrochemical cell. The microporous separator has a thickness of 5 microns and was made of polyolefin (SK Innovation). During cell assembly the separator was filled with the anolyte at 75 μL/cm² loading. The liquid electrolyte was composed of lithium bis(fluorosulfonyl)imide (LiFSI, 99+%, Fluolyte) dissolved at a 2 molar concentration in 3-methylsulfolane (TCI America, 98+%).

### Example 16

In one specific embodiment, the hybrid solid state electrochemical cell comprising the c-LLZO solid electrolyte incorporates a microporous film at the interface between the lithium metal anode and c-LLZO. This separator enables the use of a stable anolyte that reduces the interfacial impedance of the electrochemical cell. The microporous separator has a thickness of 5 microns and was made of polyolefin (SK Innovation). During cell assembly the separator was filled with the anolyte at 75 μL/cm² loading. The liquid electrolyte was composed of lithium bis(fluorosulfonyl)imide (LiFSI, 99+%, Fluolyte) dissolved at a 4 molar concentration in 1,2-dimethoxyethane (DME, 99.5%, Frontier Scientific).

We claim:

1. A solid-state or hybrid battery comprising:
a cathode-side and an anode-side;
at least one electrolyte;
at least one active material; and
at least one composite electrode located on the cathode-side or the anode side, or both, wherein the composite electrode comprises a three-dimensional porous scaffold that exhibits ionic conductivity, electronic conductivity, or both,
wherein the three-dimensional porous scaffold, electrolyte and active material are configured to provide ion and electron conductivity that enables electrochemically-active material loadings in excess of 2.5 mAh/cm².

2. A solid-state or hybrid battery containing a secondary phase conducting interlayer at the electrode/electrolyte interface enabling cell area specific resistance lower than 100 Ohm-cm² and specific energy greater than 350 Wh/kg.

3. The solid-state or hybrid battery of claim 1, wherein the three-dimensional porous scaffold comprises a plurality of ion-conducting regimes and electron-conducting regimes.

4. The solid-state or hybrid battery of claim 1, further comprising one or more separators that exhibit shear modulus greater than 8.5 MPa, sufficient to retard dendrite growth located between the anode and cathode of the composite hybrid electrodes that restricts the passage of electrons between terminals.

5. The solid-state or hybrid battery of claim 4, further comprising multiple separators with the same or different class of materials.

6. The solid-state or hybrid battery of claim 4, wherein the one or more separators comprises a polymer electrolyte, ceramic electrolyte, glass electrolyte, liquid electrolyte or combinations thereof.

7. The solid-state or hybrid battery of claim 4, wherein the one or more separators comprises a porous material selected from the group consisting of liquid, solid, glass, polymer, ceramic or combinations thereof.

8. The solid-state or hybrid battery of claim 1, further comprising multiple three-dimensional porous scaffolds, each having ionic conductivity, electronic conductivity, or both with different or the same functionality and/or different or the same class of materials in the battery.

9. The solid-state or hybrid battery of claim 1, comprising a composite solid-state electrode, a hybrid electrode or both, having an electrolyte component with ionic conductivity in excess of 1E-4 S/m.

10. The solid-state or hybrid battery of claim 9, wherein the composite solid-state electrode, hybrid electrode or both has an electronic conductivity in excess of 1E-1 S/m.

11. The solid-state or hybrid battery of claim 9, comprising a plurality of a solid-state electrolyte, hybrid electrolyte, or both with porosity in excess of 30% that is contact with an electrochemically-active electrode material.

12. The solid-state or hybrid battery of claim 11, comprising a plurality of a solid-state electrolyte, hybrid electrolyte, or both with porosity in excess of 60% that is contact with an electrochemically-active electrode material.

13. The solid-state or hybrid battery of claim 1, wherein the electrochemically active material has interstitial porosity less than 50%.

14. The solid-state or hybrid battery of claim 13, wherein the electrochemically active material has interstitial porosity less than 30%.

15. The solid-state or hybrid battery of claim 1, wherein the composite electrodes contain a liquid electrolyte in contact with either or both porous scaffold with either or both ionic conductivity, electronic conductivity and an electrochemically active electrode material.

16. The solid-state or hybrid battery of claim 1, further comprising at least one current collector that is comprised of a plurality of foil, sheet, woven mesh, expanded sheet, perforated sheet, foam, honeycomb, or wool.

17. The solid-state or hybrid battery of claim 1, wherein a coating is placed on the current collector that serves as a melt adhesive, pressure sensitive adhesive, or both with electronic conductivity in excess of 1E-1 S/m.

18. The solid-state or hybrid battery of claim 16, wherein the electrolyte is introduced into the composite electrode prior to current collector attachment.

21. The solid-state or hybrid battery of claim 1, wherein the three-dimensional porous electrode has thickness of ranging from 50 μm to 1,000 μm.

22. The solid-state or hybrid battery of claim 21, wherein the three-dimensional porous electrode has thickness of ranging from 150 μm to 500 μm.

23. The solid-state or hybrid battery of claim 1, wherein the three-dimensional porous scaffold with ionic conductivity, electronic conductivity, or both is filled with electrochemically-active material using a slurry comprising 60-95 wt % of electrochemically-active material, 1-20 wt % conductive additive, and 1-20 wt % binder.

24. The solid-state or hybrid battery of claim 1, further comprising at least one conductive, polymer inside of the three-dimensional porous electrode with ionic conductivity, electronic conductivity, or combinations thereof.

25. The solid-state or hybrid battery of claim 1, further comprising a separator between the anode and cathode, wherein the separator comprising a material that allows passage of only cations.

26. The solid-state or hybrid battery of claim 1, wherein the electrochemically-active material slurry contains a binder with ionic conductivity, electronic conductivity or combinations thereof.

27. The solid-state or hybrid battery of claim 1, comprising conducting material that is in contact with the electrochemically-active material in the cathode that is different from the conducting material that is in contact electrochemically-active material in the anode.

28. The solid-state or hybrid battery of claim 1, wherein the three-dimensional porous scaffold, electrolyte and active material are designed to provide ion and electron conductivity that enables electrochemically-active material loadings in excess of 8 mAh/cm2.

29. A method of making the solid-state or hybrid battery, comprising:
a cathode-side and an anode-side;
at least one electrolyte;
at least one active material; and
at least one composite electrode located on the cathode-side or the anode side, or both, wherein the composite electrode comprises a three-dimensional porous scaffold that exhibits ionic conductivity, electronic conductivity, or both,
the method comprising configuring three-dimensional porous scaffold to provide ion and electron conductivity that enables electrochemically-active material loadings in excess of 2.5 mAh/cm2, wherein said configuring comprising:
adding electrochemically-active materials, binders, conductive additives or combinations thereof into the three-dimensional porous scaffold with at least one technique chosen from gravity, vibration, magnetism, electric fields, pressure, vacuum, heat, or combinations thereof.

30. The method of claim 29, wherein the electrochemically-active materials, binders, conductive additives or combinations thereof are inserted into the three-dimensional porous scaffold without the addition of solvent.

31. The method of claim 29, wherein the three-dimensional porous scaffold is reduced in thickness and porosity through at least method chosen from calendaring, polishing, sanding, grinding, milling, ablation, or combinations thereof.

32. The method of claim 29, further comprising contacting the three-dimensional porous scaffold with a device that is sufficient to remove excess materials from and/or create topographical features in the three-dimensional porous scaffold, said device chosen from a laser, an air-blade, a water-jet, or combinations thereof.

33. The method of claim 29, further comprising placing an electronically insulating and ionically conducting separator with mechanical properties sufficient to retard dendrite propagation between the cathode side and the anode side, and physically and/or chemically adhering the three-dimensional porous scaffold to the separator.

34. The method of claim 29, further comprising isolating the electrochemically-active material into domains unconnected by electronic conductivity.
